(19) United States
(12) Patent Application Publication
(10) Pub. No.: US 2010/0222925 A1
(43) Pub. Date: Sep. 2, 2010

(54) Robot control apparatus

(76) Inventor: Takashi Anezaki, Hirakata-shi (JP)

Correspondence Address: WENDEROTH, LIND & PONACK L.L.P., 1030 15th Street, N.W., Suite 400 East, Washington, DC, 20005-1503, US

(21) Appl. No.: 11/292,069

(22) Filed: Dec. 2, 2005

(30) Foreign Application Priority Data
Dec. 3, 2004 (JP) 2004-350925

(51) Int. Cl. G05B 19/04

(52) U.S. Cl. 700/253

(57) ABSTRACT

In a robot control apparatus mounted on a mobile robot, movement of a human existing in front of the robot is detected, and the robot is moved in association with the movement of the human to thereby obtain path teaching data. When the robot moves autonomously according to the path teaching data, a robot movable area with respect to the path teaching data is calculated from positions of the ceiling and walls of the robot moving space or positions of obstacles detected by a surrounding object detection unit, whereby a moving path for autonomous movement is generated. The robot is controlled to move autonomously by a drive of a drive unit according to the moving path for autonomous movement.

### BACKGROUND OF THE INVENTION

The present invention relates to a robot control apparatus which generates a path that an autonomous mobile robot can move while recognizing an area movable by the autonomous mobile robot through autonomous movement. The present invention relates to a robot control apparatus which generates a path that a robot can move while recognizing a movable area without providing a magnetic tape or a reflection tape on a part of a floor as a guiding path specifically, but providing an autonomous mobile robot with an array antenna and providing a human with a transmitter or the like to thereby detect a directional angle of the human existing in front of the robot time-sequentially and move the robot in association with the movement of the human with the human walking the basic path so as to teach the path, for example.

In conventional art, map information prepared manually in detail is indispensable relating to a method of teaching a path of an autonomous mobile robot and controlling a positional direction. For example, in the Japanese Patent No. 2825239 (Automatic Guidance Control Apparatus for Mobile body, Toshiba), a mobile body is controlled based on positional information from a storage unit of map information and a moving route and sensors provided at front side parts of the vehicle body, whereby a guide such as a guiding line is not required.

However, in teaching a mobile robot path in a home environment, it is not practical to make positional data edited by a human directly and teach it. The conventional art includes: a memory for storing map information of a mobile body moving on a floor; a first distance sensor provided on the front face of the mobile body; a plurality of second distance sensor provided in a horizontal direction on side faces of the mobile body; a signal processing circuit for signal-processing outputs of the first distance sensor and the second distance sensors, respectively; a position detection unit, into which output signals of the signal processing circuit is inputted, for calculating a shifted amount during traveling and a vehicle body angle based on detected distances of the second distance sensors, and detecting a corner part based on the detection distance of the first distance sensor and the second distance sensor, and detecting the position of the mobile body based on the map information stored on the memory; and a control unit for controlling a moving direction of the mobile body based on the detection result of the position detection unit.

The conventional art is a method of detecting a position of the mobile body based on the map information stored, and based on the result of position detection, controlling the moving direction of the mobile body. There has been no method which a map is not used for a medium for teaching in the conventional art.

In a robot path teaching and path generation in the conventional art, positional data is edited and is taught by a human directly using numeric values or visual information.

However, in teaching a mobile robot path in a home environment, it is not practical to teach positional data by being edited by a human directly. It is an object to apply a method of, for example, following human instructions in sequence.

It is therefore an object of the present invention to provide a robot control apparatus for generating a path that a robot can move while recognizing an area movable by autonomous moving after a human walks the basic path to teach the path to follow, without a need to cause a person to edit and teach positional data directly.

### SUMMARY OF THE INVENTION

In order to achieve the object, the present invention is configured as follows.

According to a first aspect of the present invention, there is provided a robot control apparatus comprising:

a human movement detection unit, mounted on a mobile robot, for detecting a human existing in front of the robot, and after detecting the human, detecting movement of the human;

a drive unit, mounted on the robot, for moving the robot, at a time of teaching a path, corresponding to the movement of the human detected by the human movement detection unit;

a robot moving distance detection unit for detecting a moving distance of the robot moved by the drive unit;

a first path teaching data conversion unit for storing the moving distance data detected by the robot moving distance detection unit and converting the stored moving distance data into path teaching data;

a surrounding object detection unit, mounted on the robot, having an omnidirectional image input system capable of taking an omnidirectional image around the robot and an obstacle detection unit capable of detecting an obstacle around the robot, for detecting the obstacle around the robot and a position of a ceiling or a wall of a space where the robot moves;

a robot movable area calculation unit for calculating a robot movable area of the robot with respect to the path teaching data from a position of the obstacle detected by the surrounding object detection unit when the robot autonomously moves by a drive of the drive unit along the path teaching data converted by the first path teaching data conversion unit; and

a moving path generation unit for generating a moving path for autonomous movement of the robot from the path teaching data and the movable area calculated by the robot movable area calculation unit; wherein

the robot is controlled by the drive of the drive unit so as to move autonomously according to the moving path generated by the moving path generation unit.

According to a second aspect of the present invention, there is provided the robot control apparatus according to the first aspect, wherein the human movement detection unit comprises:

a corresponding point position calculation arrangement unit for previously calculating and arranging a corresponding point position detected in association with movement of a mobile body including the human around the robot;

a time sequential plural image input unit for obtaining a plurality of images time sequentially;

a moving distance calculation unit for detecting corresponding points arranged by the corresponding point position calculation arrangement unit between the plurality of time sequential images obtained by the time sequential plural image obtainment arrangement unit, and calculating a moving distance between the plurality of images of the corresponding points detected;

a mobile body movement determination unit for determining whether a corresponding point conforms to the movement of the mobile body from the moving distance calculated by the moving distance calculation unit;

a mobile body area extraction unit for extracting a mobile body area from a group of corresponding points obtained by the mobile body movement determination unit;

a depth image calculation unit for calculating a depth image of a specific area around the robot;

a depth image specific area moving unit for moving the depth image specific area calculated by the depth image calculation unit so as to conform to an area of the mobile body area extracted by the mobile body area extraction unit;

a mobile body area judgment unit for judging the mobile body area of the depth image after movement by the depth image specifying area moving unit;

a mobile body position specifying unit for specifying a position of the mobile body from the depth image mobile body area obtained by the mobile body area judgment unit; and

a depth calculation unit for calculating a depth from the robot to the mobile body from the position of the mobile body specified on the depth image by the mobile body position specifying unit, and

the mobile body is specified and a depth and a direction of the mobile body are detected continuously by the human movement detection unit whereby the robot is controlled to move autonomously.

According to a third aspect of the present invention, there is provided the robot control apparatus according to the first aspect, wherein the surrounding object detection unit comprises:

an omnidirectional image input unit disposed to be directed to the ceiling and a wall surface;

a conversion extraction unit for converting and extracting a ceiling and wall surface full-view peripheral part image and a ceiling and wall surface full-view center part image from images inputted from the omnidirectional image input unit;

a conversion extraction storage unit for inputting the ceiling and wall surface full-view center part image and the ceiling and wall surface full-view peripheral part image from the conversion extraction unit and converting, extracting and storing them at a designated position in advance;

a first mutual correlation matching unit for performing mutual correlation matching between a ceiling and wall surface full-view peripheral part image inputted at a current time and the ceiling and wall surface full-view peripheral part image of the designated position stored on the conversion extraction storage unit in advance;

a rotational angle-shifted amount conversion unit for converting a positional relation in a lateral direction obtained from the matching by the first mutual correlation matching unit into a rotational angle-shifted amount;

a second mutual correlation matching unit for performing mutual correlation matching between a ceiling and wall surface full-view center part image inputted at the current time and the ceiling and wall surface full-view center part image of the designated position stored on the conversion extraction storage unit in advance; and

a displacement amount conversion unit for converting a positional relationship in longitudinal and lateral directions obtained from matching by the second mutual correlation matching unit into a displacement amount, and

matching is performed between a ceiling and wall surface full-view image serving as a reference of a known positional posture and a ceiling and wall surface full-view image inputted, and a positional posture shift of the robot including the rotational angle-shifted amount obtained by the rotational angle-shifted amount conversion unit and the displacement amount obtained by the displacement amount conversion unit is detected, whereby the robot is controlled to move autonomously by recognizing a self position from the positional posture shift.

As described above, according to the robot control apparatus of the first aspect of the present invention, in the robot control apparatus mounted on the mobile robot, movement of the human present in front of the robot is detected, and the robot is moved in accordance with the movement of the human so as to obtain path teaching data, and when the robot is autonomously moved in accordance with the path teaching data, a robot movable area with respect to the path teaching data is calculated and then moving path for autonomous movement is generated from positions of the ceiling and walls and positions of obstacles in the robot moving space detected by the surrounding object detection unit, and it is configured to control the robot to move autonomously by driving the drive unit in accordance with the moving path for autonomous movement. Therefore, the moving path area can be taught by following the human and in the robot autonomous movement.

According to the robot control apparatus of the second aspect of the present invention, it is possible to specify the mobile body and to continuously detect (depth, direction of) the mobile body in the first aspect.

According to the robot control apparatus of the third aspect of the present invention, it is possible to perform matching between the ceiling and wall surface full-view image serving as a reference of known positional posture and the ceiling and wall surface full-view image inputted so as to detect positional posture shift for recognizing the position of the robot, in the first aspect.

According to a fourth aspect of the present invention, there is provided the robot control apparatus according to the second aspect, further comprising a teaching object mobile body identifying unit for confirming an operation of the mobile body to designate tracking travel of the robot with respect to the mobile body, wherein with respect to the mobile body confirmed by the teaching object mobile body identifying unit, the mobile body is specified and the depth and the direction of the mobile body are detected continuously whereby the robot is controlled to move autonomously.

According to a fifth aspect of the present invention, there is provided the robot control apparatus according to the second aspect, wherein the mobile body is a human, and the human who is the mobile body is specified and the depth and the direction between the human and the robot are detected continuously whereby the robot is controlled to move autonomously.

According to a sixth aspect of the present invention, there is provided the robot control apparatus according to the second aspect, further comprising a teaching object mobile body identifying unit for confirming an operation of a human who is the moving object to designate tracking travel of the robot with respect to the human, wherein with respect to the human confirmed by the teaching object mobile body identifying unit, the human is specified and the depth and the direction between the human and the robot are detected continuously whereby the robot is controlled to move autonomously.

According to a seventh aspect of the present invention, there is provided the robot control apparatus according to the second aspect, wherein the human movement detection unit comprises:

an omnidirectional time sequential plural image obtaining unit for obtaining a plurality of omnidirectional, time sequential images of the robot; and

a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and

the mobile body is specified and the depth and the direction between the mobile body and the robot are detected continuously whereby the robot is controlled to move autonomously.

According to an eighth aspect of the present invention, there is provided the robot control apparatus according to the third aspect, wherein the human movement detection unit comprises:

an omnidirectional time sequential plural image obtaining unit for obtaining a plurality of omnidirectional time sequential images of the robot; and

a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and

the mobile body is specified, and the depth and the direction between the mobile body and the robot are detected continuously whereby the robot is controlled to move autonomously.

According to a ninth aspect of the present invention, there is provided the robot control apparatus according to the fourth aspect, wherein the human movement detection unit comprises:

an omnidirectional time sequential plural image obtaining unit for obtaining a plurality of omnidirectional time sequential images of the robot; and

a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and

the mobile body is specified and the depth and the direction between the mobile body and the robot are detected continuously whereby the robot is controlled to move autonomously.

According to a 10th aspect of the present invention, there is provided the robot control apparatus according to the fifth aspect, wherein the human movement detection unit comprises:

an omnidirectional time sequential plural image obtaining unit for obtaining a plurality of omnidirectional time sequential images of the robot; and

a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and

the mobile body is specified, and the depth and the direction between the mobile body and the robot are detected continuously whereby the robot is controlled to move autonomously.

According to an 11th aspect of the present invention, there is provided the robot control apparatus according to the sixth aspect, wherein the human movement detection unit comprises:

an omnidirectional time sequential plural image obtaining unit for obtaining a plurality of omnidirectional time sequential images of the robot; and

a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and

the mobile body is specified and the depth and the direction between the mobile body and the robot are detected continuously whereby the robot is controlled to move autonomously.

According to a 12th aspect of the present invention, there is provided the robot control apparatus according to the fifth aspect, further comprising a corresponding point position calculation arrangement changing unit for changing a corresponding point position calculated, arranged, and detected in association with the movement of the human in advance according to the human position each time, wherein

the human is specified, and the depth and the direction between the human and the robot are detected whereby the robot is controlled to move autonomously.

As described above, according to the robot control apparatus of the present invention, it is possible to specify the mobile body and to detect (depth and direction of) the mobile body continuously.

According to a 13th aspect of the present invention, there is provided the robot control apparatus according to the first aspect, comprising:

an omnidirectional image input unit capable of obtaining an omnidirectional image around the robot;

an omnidirectional camera height adjusting unit for arranging the image input unit toward the ceiling and a wall surface in a height adjustable manner;

a conversion extraction unit for converting and extracting a ceiling and wall surface full-view peripheral part image and a ceiling and wall surface full-view center part image from images inputted from the image input unit;

a conversion extraction storage unit for inputting the ceiling and wall surface full-view center part image and the ceiling and wall surface full-view peripheral part image from the conversion extraction unit and converting, extracting and storing the ceiling and wall surface full-view center part image and the ceiling and wall surface full-view peripheral part image at a designated position in advance;

a first mutual correlation matching unit for performing mutual correlation matching between a ceiling and wall surface full-view peripheral part image inputted at a current time and the ceiling and wall surface full-view peripheral part image of the designated position stored on the conversion extraction storage unit in advance;

a rotational angle-shifted amount conversion unit for converting a shifted amount which is a positional relationship in a lateral direction obtained from the matching by the first mutual correlation matching unit into a rotational angle-shifted amount;

a second mutual correlation matching unit for performing mutual correlation matching between a ceiling and wall surface full-view center part image inputted at a current time and the ceiling and wall surface full-view center part image of the designated position stored on the conversion extraction storage unit in advance; and

a unit for converting a positional relationship in longitudinal and lateral directions obtained from the matching by the second mutual correlation matching unit into a displacement amount, wherein

matching is performed between a ceiling and wall surface full-view image serving as a reference of a known positional posture and a ceiling and wall surface full-view image inputted, and a positional posture shift detection is performed based on the rotational angle-shifted amount obtained by the rotational angle-shifted amount conversion unit and the displacement amount obtained by the displacement amount conversion unit whereby the robot is controlled to move autonomously by recognizing a self position of the robot.

According to the robot control apparatus of the present invention, the ceiling and wall surface full-view image is inputted by an omnidirectional camera attached to the robot which is an example of the omnidirectional image input unit, and displacement information with the ceiling and wall surface full-view image of the target point having been image-inputted and stored in advance is calculated, and path-totalized amount and displacement information by an encoder attached to the wheel of the drive unit of the robot for example are included to a carriage motion equation so as to perform a carriage positional control, and the deviation from the target position is corrected while moving whereby indoor operation by an operating apparatus such as a robot is performed.

Thereby, map information prepared in detail or a magnetic tape or the like provided on a floor is not required, and further, it is possible to move the robot corresponding to various indoor situations.

According to the present invention, displacement correction during movement is possible, and operations at a number of points can be performed continuously in a short time. Further, by image-inputting and storing the ceiling and wall surface full-view image of the target point, designation of a fixed position such as a so-called landmark is not needed.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1A is a control block diagram of a robot control apparatus according to first to third embodiments of the present invention;

FIG. 1B is a front view of a robot controlled by the robot control apparatus according to the first embodiment of the present invention;

FIG. 2 is a side view of a robot controlled by the robot control apparatus according to the first embodiment of the present invention;

FIG. 3 is an illustration view for explaining direct teaching of a basic path of the robot controlled by the robot control apparatus according to the first embodiment of the present invention;

FIG. 4 is an illustration view for explaining learning of a movable area of the robot controlled by the robot control apparatus according to the first embodiment of the present invention;

FIG. 5 is an illustration view for explaining generation of a path within the movable area of the robot controlled by the robot control apparatus according to the first embodiment of the present invention;

FIGS. 6A, 6B, and 6C are illustration views and a block diagram for explaining a case of monitoring a directional angle of a human time-sequentially to thereby detect movement of a human from time-sequential directional angle change data in the robot control apparatus in the first embodiment of the present invention, respectively;

FIG. 7 is a flowchart showing operation of a playback-type navigation in the robot control apparatus according to the first embodiment of the present invention;

FIGS. 8A, 8B, and 8C are an illustration view for explaining operation of human tracking basic path teaching, a view of an image picked-up by an omnidirectional camera, and a view for explaining a state where the robot moves within a room, respectively, in the robot control apparatus according to the first embodiment of the present invention;

FIGS. 9A and 9B are an illustration view for explaining operation of human tracking basic path teaching, and an illustration view showing a state where the robot moves inside the room and a time sequential ceiling full-view image of an omnidirectional optical system, respectively, in the robot control apparatus according to the first embodiment of the present invention;

FIG. 10 is an illustration view showing a state where the robot moves inside the room and a time sequential ceiling full-view image of the omnidirectional optical system for explaining a playback-type autonomous moving in the robot control apparatus according to the first embodiment of the present invention;

FIGS. 11A and 11B are an illustration view of a ceiling full-view image of the omnidirectional optical system when the human is detected, and an illustration view for explaining a case of following the human, respectively, in the robot control apparatus according to the first embodiment of the present invention;

FIGS. 12A and 12B are control block diagrams of mobile robot control apparatuses according to the second embodiment of the present invention and its modification, respectively;

FIG. 13 is a diagram showing an optical flow which is conventional art;

FIGS. 14A, 14B, 14C, 14D, and 14E are an illustration view picked-up by using an omnidirectional camera in a mobile body detection method according to the second embodiment of the present invention, and illustration views showing arrangement examples of various corresponding points to the image picked-up in a state where the corresponding points (points-for-flow-calculation) are limited to a specific area of the human or a mobile body by means of the mobile body detection method according to the second embodiment of the present invention so as to reduce the computation cost, respectively;

FIGS. 15A and 15B are an illustration view of a group of acceptance-judgment-corresponding points in an image picked-up by the omnidirectional camera, and an illustration view showing the result of extracting a human area from the group of acceptance-judgment-corresponding points, respectively, in the mobile body detection method according to the second embodiment of the present invention;

FIG. 15C is an illustration view of a result of extracting the head of a human from a specific gray value-projected image of the human area panoramic image by using the human area panoramic image generated from an image picked-up by an omnidirectional camera and, in the mobile body detection method according to the second embodiment of the present invention;

FIGS. 16A and 16B are an illustration view for explaining corresponding points of the center part constituting a foot (near floor) area of a human in an image picked-up by the omnidirectional camera when the omnidirectional optical system is used, and an illustration view for explaining that a flow (noise flow) other than an optical flow generated by movement of the human and an article is easily generated in the corresponding points of four corner areas which are outside the omnidirectional optical system, respectively, in the mobile body detection method according to the second embodiment of the present invention;

FIG. 17 is an illustration view showing a state of aligning panoramic development images of an omnidirectional camera image in which depths from the robot to the human are different, for explaining a method of calculating a depth to the human on the basis of a feature position of the human, in the mobile body detection method according to the second embodiment of the present invention;

FIG. 18A is an illustration view for explaining a state where the robot moves inside a room for explaining a depth image detection of a human based on a human area specified, in the mobile body detection method according to the second embodiment of the present invention;

FIG. 18B is a view of an image picked-up by the omnidirectional camera for explaining a depth image detection of a human based on the human area specified, in the mobile body detection method according to the second embodiment of the present invention;

FIG. 18C is an illustration view of a case of specifying a mobile body position from a mobile body area of a depth image for explaining the depth image detection of the human based on the human area specified, in the mobile body detection method according to the second embodiment of the present invention;

FIG. 18D is an illustration view of a case of determining the mobile body area of the depth image for explaining the depth image detection of the human based on the human area specified, in the mobile body detection method according to the second embodiment of the present invention;

FIG. 19 is a flowchart showing processing of the mobile body detection method according to the second embodiment of the present invention;

FIG. 20A is a control block diagram of a robot having a robot positioning device of a robot control apparatus according to a third embodiment of the present invention;

FIG. 20B is a block diagram of an omnidirectional camera processing unit of the robot control apparatus according to the third embodiment of the present invention;

FIG. 21 is a flowchart of robot positioning operation in the robot control apparatus according to the third embodiment of the present invention;

FIG. 22 is an illustration view for explaining the characteristics of an input image when using a PAL-type lens or a fish-eye lens in one example of an omnidirectional image input unit, in the robot positioning device of the robot control apparatus according to the third embodiment of the present invention;

FIG. 23 is an illustration view for explaining operational procedures of an omnidirectional image input unit, an omnidirectional camera height adjusting unit for arranging the image input unit toward the ceiling and the wall surface in a height adjustable manner, and a conversion extraction unit for converting and extracting a ceiling and wall surface full-view peripheral part image and a ceiling and wall surface full-view center part image from images inputted by the image input unit, in the robot positioning device of the robot control apparatus according to the third embodiment of the present invention;

FIG. 24 is an illustration view for explaining operational procedures of the omnidirectional image input unit and the conversion extraction unit for converting and extracting a ceiling and wall surface full-view peripheral part image from images inputted by the image input unit, in the robot positioning device of the robot control apparatus according to the third embodiment of the present invention;

FIGS. 25A, 25B, and 25C are illustration views showing a state of performing mutual correlation matching, as one actual example, between a ceiling and wall surface full-view peripheral part image and a ceiling and wall surface full-view center part image inputted at the current time (a time of performing positioning operation) and ceiling and wall surface full-view peripheral part image and a ceiling and wall surface full-view center part image of a designated position stored in advance, in the robot positioning device of the robot control apparatus according to the third embodiment of the present invention; and

FIG. 26 is an illustration view for explaining addition of a map when the robot performs playback autonomous movement based on the map of basic path relating to FIGS. 25A, 25B, and 25C in the robot positioning device of the robot control apparatus according to the third embodiment of the present invention.

### DETAILED DESCRIPTION OF THE PREFERRED EMBODIMENTS

Before the description of the present invention proceeds, it is to be noted that like parts are designated by like reference numerals throughout the accompanying drawings.

Hereinafter, detailed explanation will be given for various embodiments according to the present invention in accordance with the accompanying drawings.

### First Embodiment

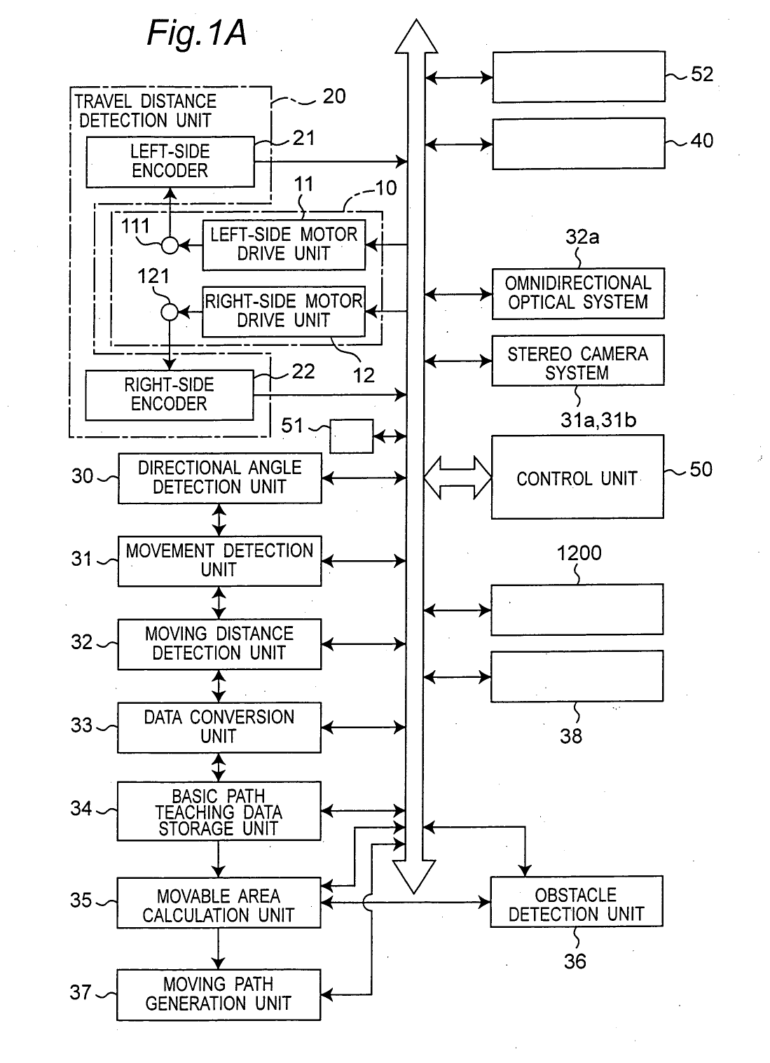

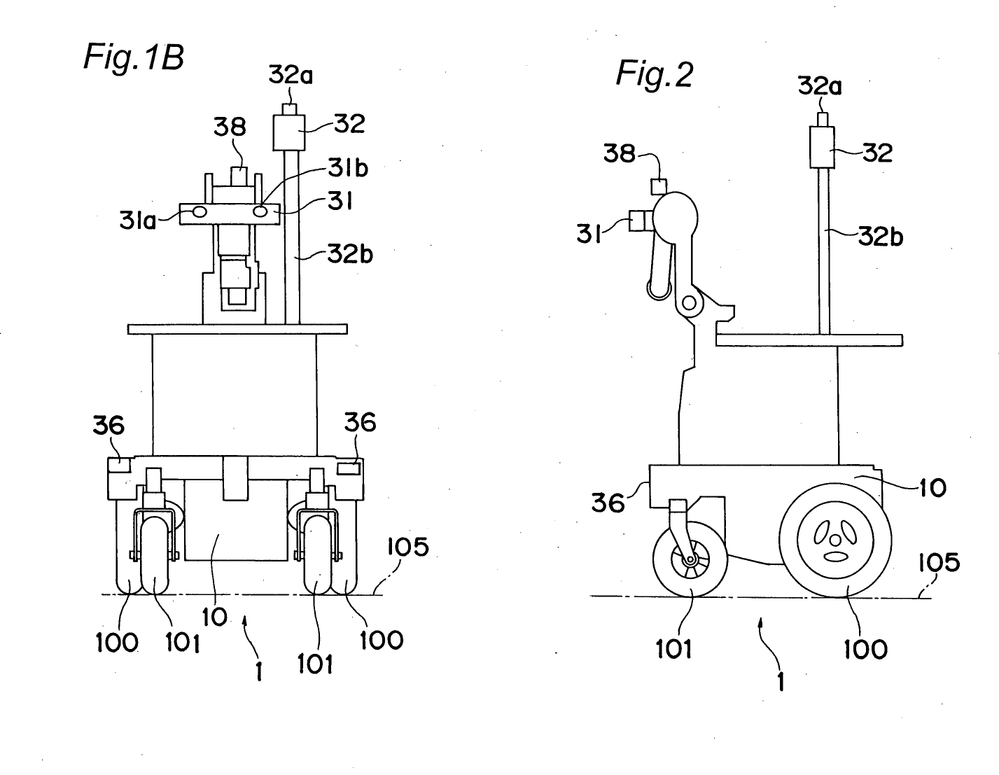

As shown in FIG. 1A, a robot control apparatus according to a first embodiment of the present invention is mounted on a robot 1, capable of traveling on a travel floor 105 of a large almost flat plane, for controlling movement of the mobile robot 1 forward and backward and in right and left sides. The robot control apparatus is configured to include, specifically, a drive unit 10, a travel distance detection unit 20, a directional angle detection unit 30, a human movement detection unit 31, a robot moving distance detection unit 32, a robot basic path teaching data conversion unit 33, a robot basic path teaching data storage unit 34, a movable area calculation unit 35, an obstacle detection unit 36, a moving path generation unit 37, and a control unit 50 for operation-controlling each of the drive unit 10 through the moving path generation unit 37.

The drive unit 10 is configured to include a left-side motor drive unit 11 for driving a left-side traveling motor 111 so as to move the mobile robot 1 to the right side, and a right-side motor drive unit 12 for driving a right-side traveling motor 121 so as to move the mobile robot 1 to the left side. Each of the left-side traveling motor 111 and the right-side traveling motor 121 is provided with a rear-side drive wheel 100 shown in FIG. 1B and FIG. 2. When moving the mobile robot 1 to the right side, the left-side traveling motor 111 is rotated more than the rotation of the right side traveling motor 121 by the left-side motor drive unit 11. In contrast, when moving the mobile robot 1 to the left side, the right-side traveling motor 121 is rotated more than the rotation of the left-side traveling motor 111 by the right-side motor drive unit 12. When moving the mobile robot 1 forward or backward, the left-side traveling motor 111 and the right-side traveling motor 121 are made to rotate forward or backward together by synchronizing the left-side motor drive unit 11 and the right-side motor drive unit 12. Note that on the front side of the robot 1, a pair of front side auxiliary traveling wheels 101 are arranged so as to be capable of turning and rotating freely.

Further, the travel distance detection unit 20 is to detect a travel distance of the mobile robot 1 moved by the drive unit 10 and then output travel distance data. A specific example of configuration of the travel distance detection unit 20 includes: a left-side encoder 21 for generating pulse signals proportional to the number of rotations of the left-side drive wheel 100 driven by a control of the drive unit 10, that is, the number of rotations of the left-side traveling motor 111, so as to detect the travel distance that the mobile robot 1 has moved to the right side; and a right-side encoder 22 for generating pulse signals proportional to the number of rotations of the right-side drive wheel 100 driven by the control of the drive unit 10, that is, the number of rotations of the right-side traveling motor 121, so as to detect the travel distance that the mobile robot 1 has moved to the left side. Based on the travel distance that the mobile robot 1 has moved to the right side and the traveling distance that it has moved to the left side, the traveling distance of the mobile robot 1 is detected whereby the travel distance data is outputted.

The directional angle detection unit 30 is, in the mobile robot 1, to detect a change in the traveling direction of the mobile robot 1 moved by the drive unit 10 and then output travel directional data. For example, the number of rotations of the left-side drive wheel 100 from the left-side encoder 21 is totalized to be the moving distance of the left-side drive wheel 100, and the number of rotations of the right-side drive wheel 100 from the right-side encoder 22 is totalized to be the moving distance of the right-side drive wheel 100, and a change in the travel direction of the robot 1 may be calculated from information of the both moving distance, and then the travel directional data may be outputted.

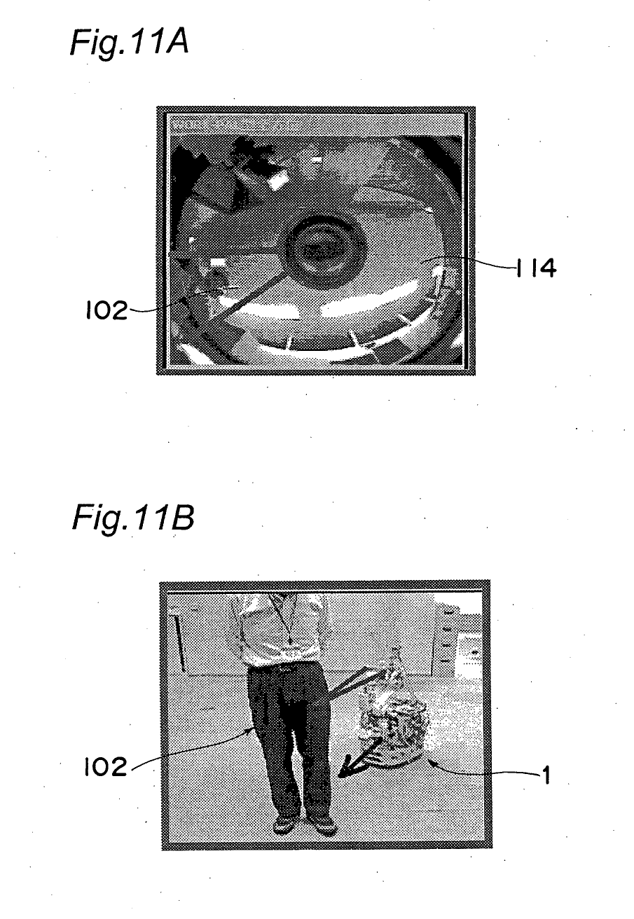

The human movement detection unit 31, in the mobile robot 1, uses image data picked-up by an omnidirectional optical system 32a as an example of an omnidirectional image input system fixed at the top end of a column 32b erected, for example, at the rear part of the robot 1 as shown in human detection of FIG. 11A and an optical flow calculation to thereby detect a human existing around the robot 1. More specifically, as a result of the optical flow calculation, if there is a continuous object (having a length in a radius direction of the omnidirectional image) in a certain angle (30° to 100°, the best angle is about 70°) within the omnidirectional image, it is determined that a human 102 exists to thereby detect the human 102, and stereo cameras 31a and 31b arranged in, for example, the front part of the robot 1 are directed to the center angle.

Further, as shown in human tracking by the robot 1 such as FIG. 11B, by using image data picked-up by the stereo camera system 31a and 31b arranged, for example, at the front part of the robot 1, the human 102 moving in front of the robot 1 is detected, and the directional angle and the distance (depth) of the human 102 existing in front of the robot 1 are detected, whereby the directional angle and distance (depth) data of the human 102 are outputted. More specifically, based on the area of the human detected in the omnidirectional image, gray values (depth values) of the image of the human part in the image data picked-up by the stereo camera system 31a and 31b are averaged whereby positional data of the human 102 (distance (depth) data between the robot 1 and the human 102) is calculated, and the directional angle and the distance (depth) of the human 102 are detected, and the directional angle and the distance (depth) of the human 102 are outputted.

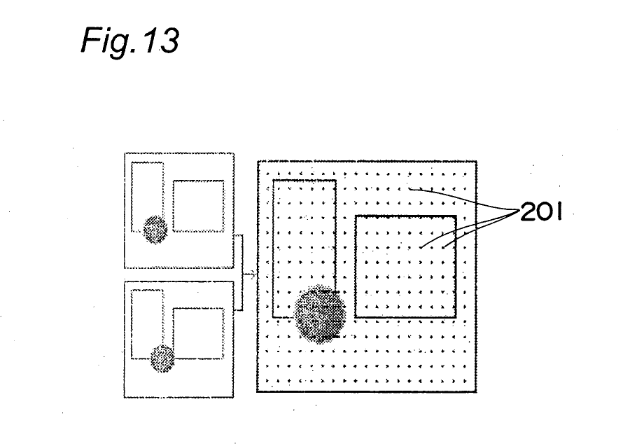

Here, the omnidirectional optical system 32a is composed of an omnidirectional camera, for example. The omnidirectional camera is one using a reflecting optical system, and is composed of one camera disposed facing upward and a composite reflection mirror disposed above, and with the one camera, a surrounding omnidirectional image reflected by the composite reflection mirror can be obtained. Here, an optical flow means one that what velocity vector each point in the frame has is obtained in order to find out how the robot 1 moves since it is impossible to obtain how the robot 1 moves only with a difference between picked-up image frames picked-up at each predetermined time by the omnidirectional optical system 32a (see FIG. 13).

The robot moving distance detection unit 32 monitors the directional angle and the distance (depth) detected by the human movement detection unit 31 time-sequentially, and at the same time; picks-up a full-view image of the ceiling of the room where the robot 1 moves above the robot 1 by the omnidirectional optical system 32a time-sequentially so as to obtain ceiling full-view image data; and moves the robot 1 by the drive unit 10 in accordance with moving locus (path) of the human (while reproducing the moving path of the human); and by using moving directional data and moving depth data of the robot 1 outputted from the directional angle detection unit 30 and the travel distance detection unit 20, detects the moving distance composed of the moving direction and moving depth of the robot 1; and outputs moving distance data to the robot basic path teaching data conversion unit 33 and the like. The moving distance of the robot 1 is, for example, the number of rotations of the left-side drive wheel 100 from the left-side encoder 21 is totalized to be the moving distance of the left-side drive wheel 100, and the number of rotations of the right-side drive wheel 100 from the right-side encoder 22 is totalized to be the moving distance of the right-side drive wheel 100, and the moving distance of the robot 1 can be calculated from information of the both moving distances.

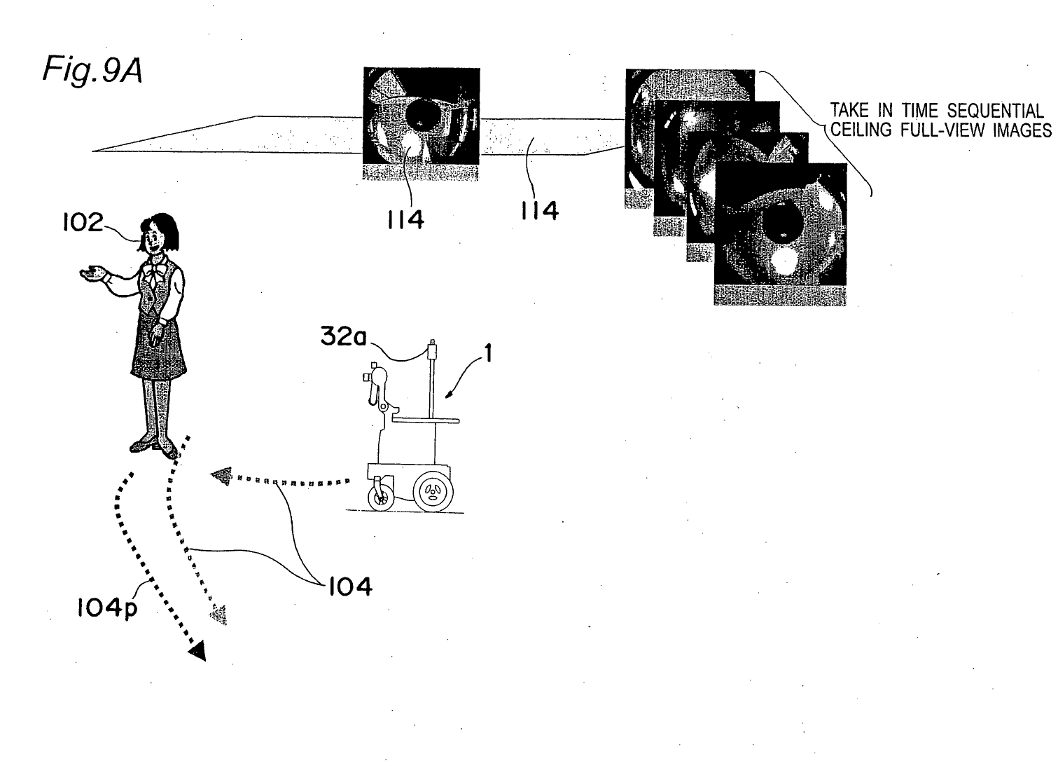

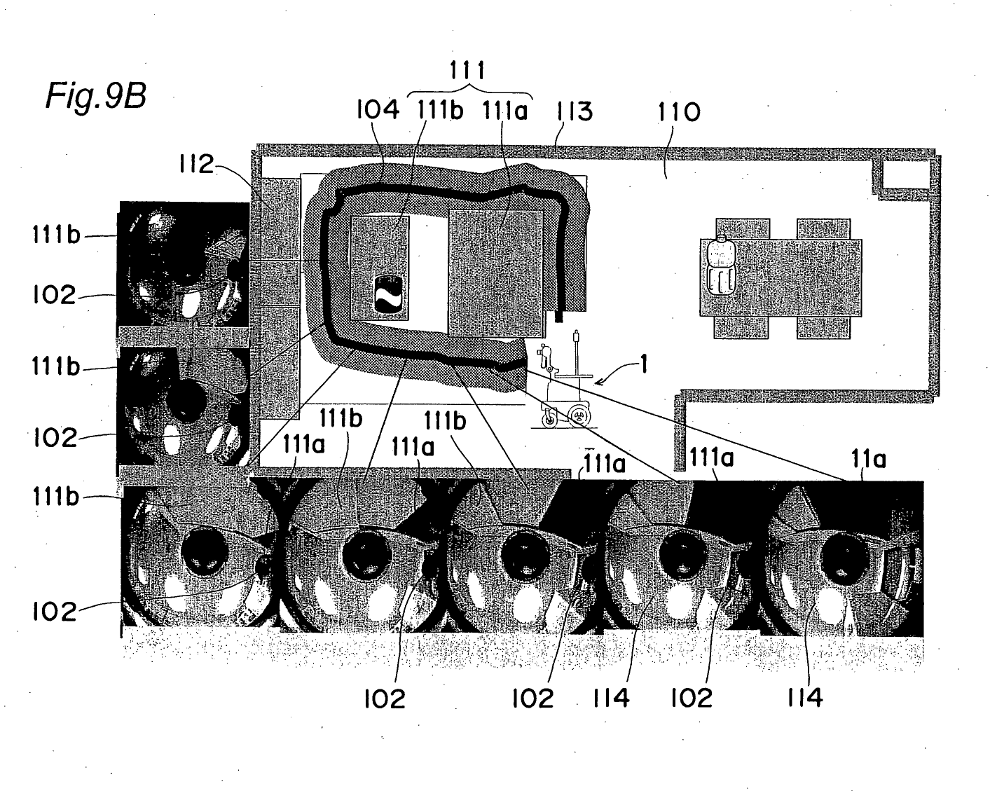

The robot basic path teaching data conversion unit 33 stores detected data of the moving distance (moving direction and moving depth of the robot 1 itself, ceiling full-view image data of the omnidirectional optical system 32a—teaching result of FIG. 9B) time-sequentially, converts the accumulated data into basic path teaching data, and outputs the converted data to the robot basic path teaching data storage unit 34 and the like.

The robot basic path teaching data storage unit 34 stores robot basic path teaching data outputted from the robot basic path teaching data conversion unit 33, and outputs the accumulated data to the movable area calculation unit 35 and the like.

The movable area calculation unit 35 detects the position of an obstacle 103 with an obstacle detection unit 36 such as ultrasonic sensors arranged, for example, on the both sides of the front part of the robot 1 while autonomously moving the robot 1 based on the robot basic path teaching data stored in the robot basic path teaching data storage unit 34, and by using obstacle information calculated, calculates data of an area (movable area) 104a that the robot 1 is movable in a width direction with respect to the basic path 104 in which movement of the robot 1 is not interrupted by the obstacle 103, that is movable area data, and outputs the calculated data to the moving path generation unit 37 and the like.

The moving path generation unit 37 generates a moving path optimum for the robot 1 from the movable area data outputted from the movable area calculation unit 35, and outputs it.

Further, in FIG. 1A, to the control unit 50, travel distance data detected by the travel distance detection unit 20 and travel directional data detected by the directional angle detection unit 30 are inputted at predetermined time intervals. The control unit 50 is configured as a central processing unit (CPU) for calculating the current position of the mobile robot 1 based on the travel distance data and the travel direction data inputted in the control unit 50, drive-controlling the drive unit 10 by the control unit 50 based on the current position of the mobile robot 1 obtained from the calculation result and the moving path outputted from the moving path generation unit 37, and operate-controlling the mobile robot 1 so that the mobile robot 1 can travel accurately to the target point without deviating the moving path which is the normal route. Note that the control unit 50 is adapted to operate-controls other parts too.

Hereinafter, explanation will be given for a positioning device and a positioning method for the mobile robot 1 configured as described above, and actions and effects of the control apparatus and the method.

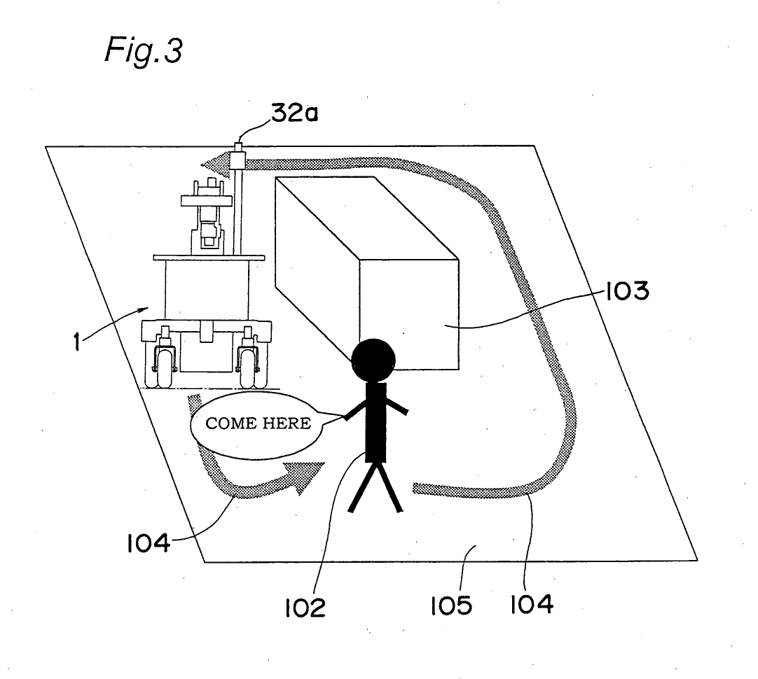

FIG. 3 shows a basic path direct teaching method of the mobile robot 1. The basic path direct teaching method of the mobile robot 1 is: moving the robot 1 along the basic path 104 by following a human 102 traveling along the basic path; accumulating positional information at the time of moving the robot in the basic path teaching data storage unit 34 of the robot 1; converting the accumulated positional information into basic path teaching data of the robot 1 by the robot basic path teaching data conversion unit 33 based on the accumulated positional information; and storing the basic path teaching data in the basic path teaching data storage unit 34.

As a specific method of the basic path direct teaching method, while a human 102 existing around the robot 1, for example, in front thereof, is detected by using the omnidirectional image input system 32a etc. of the movement detection unit 31 of the human 102, and by driving the drive unit 10 of the robot 1, the robot 1 moves so as to follow the human 102 walking the basic path 104. That is, when the robot 1 moves while the drive unit 10 of the robot 1 is drive-controlled by the control unit 50 such that the depth between the robot 1 and the human 102 falls within an allowable area (for example, a distance area in which the human 102 will not contact the robot 1 and the human 102 will not go off the image taken by the omnidirectional image input system 32a), positional information at the time that the robot is moving is accumulated and stored on the basic path teaching data storage unit 34 to be used as robot basic path teaching data. Note that in FIG. 3, the reference numeral 103 indicates an obstacle.

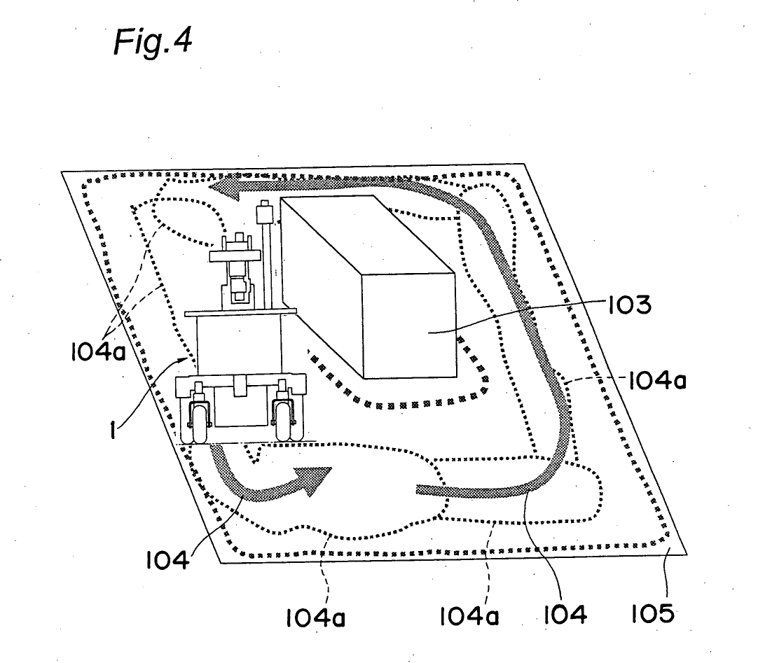

FIG. 4 shows movable area additional learning by the robot 1. The movable area additional learning means to additionally learn a movable area relating to the robot basic path teaching data, which is a movable area when avoiding the obstacle 103 or the like.

Based on the robot basic path teaching data by the human 102, obstacle information such as position and size of an obstacle detected by the obstacle detection unit 36 such as an ultrasonic sensor is used, and when the robot 1 nearly confronts the obstacle or the like 103 when autonomously moving, the control unit 50 controls the drive unit 10 in each case so as to cause the robot 1 to avoid the obstacle 103 before the obstacle 103, then cause the robot 1 to autonomously move along the basic path 104 again. Each time the robot 1 nearly confronts the obstacle 103 or the like, this is repeated to thereby expand the robot basic path teaching data along the traveling floor 105 of the robot 1. The final expanded plane obtained finally by being expanded is stored on the basic path teaching data storage unit 34 as a movable area 104a of the robot 1.

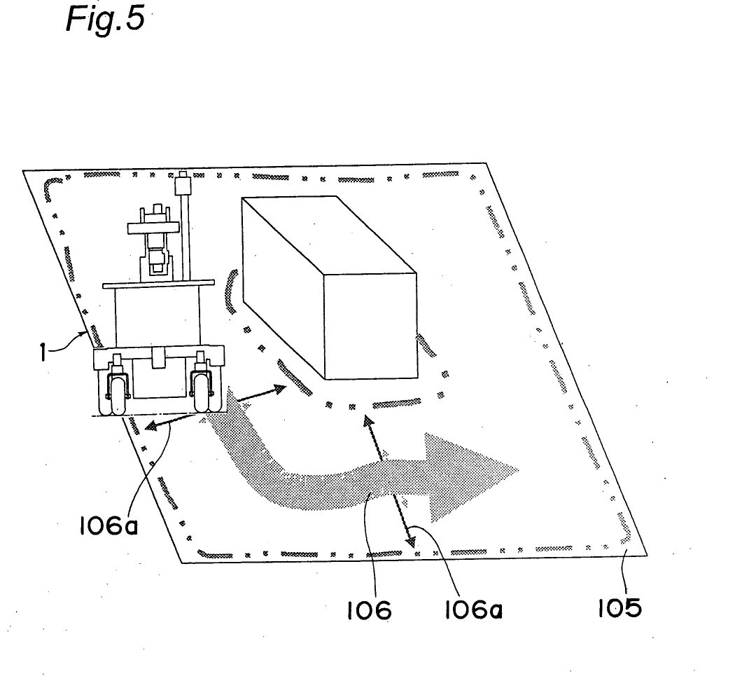

FIG. 5 shows generation of a path within a movable area by the robot 1.

The moving path generation unit 37 generates a moving path optimum to the robot 1 from the movable area 104a obtained by the movable area calculation unit 35. Basically, the center part in the width direction of the plane of the movable area 104a is generated as the moving path 106. More specifically, components 106a in the width direction of the plane of the movable area 104a are first extracted at predetermined intervals, and then the center parts of the components 106a in the width direction are linked and generated as the moving path 106.

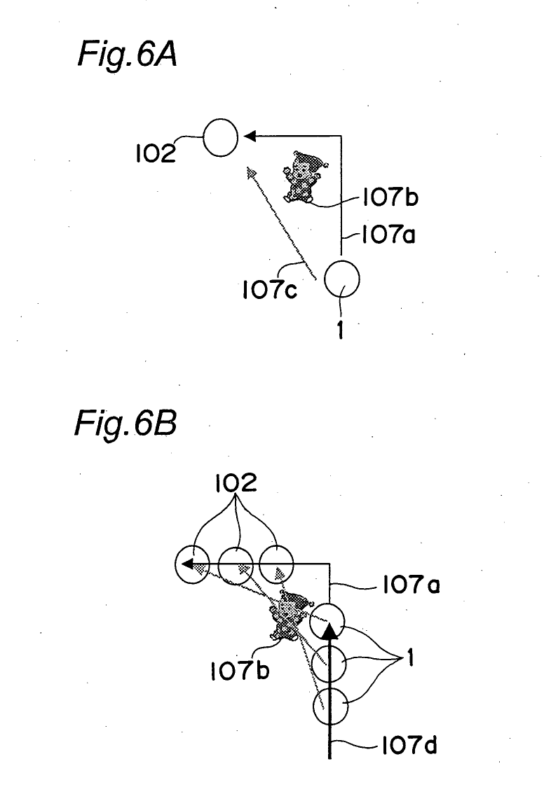

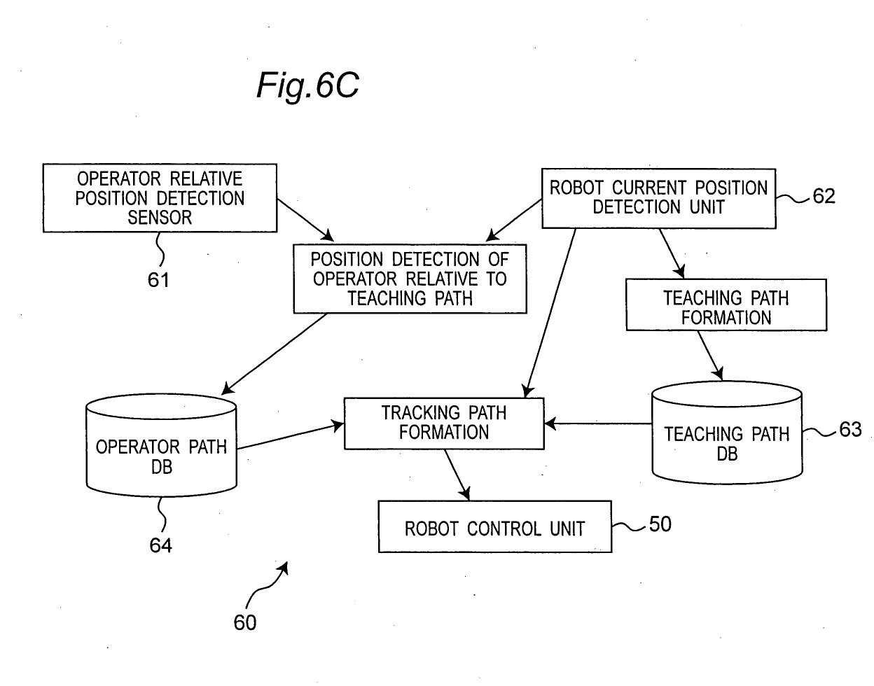

Here, in tracking (following) teaching, in a case where only moving directional information of the human 102 who is an operator for teaching is used and the position of the human 102 is followed straightly, the human 102 moves a path 107a cornering about 90 degrees in order to avoid a place 107b where a baby is in, as shown in FIG. 6A. As a result, if the robot 1 operates to select a shortcut 107c near the corner, the robot 1 will move through the place 107b where the baby is in as shown in FIG. 6B, so there may be a case where correct teaching cannot be done.

In view of the above, in the first embodiment, information of both moving direction and moving depth of the human 102 is used, and it is attempted to realize a control to set a path 107a which is the path of the operator as a path 107d of the robot 1 with a system like that shown in FIG. 6C (see FIG. 6B).

The system 60 in FIG. 6C detects the position of the human 102, who is an operator, relative to the teaching path, by using an operator relative position detection sensor 61 corresponding to the omnidirectional optical system 32a and the stereo camera system 31a and 31b and the like; and a robot current position detection unit 62 composed of the travel distance detection unit 20, the directional angle detection unit 30, the control unit 50, and the like, and stores the path of the human 102 in the path database 64. Further, based on the current position of the robot 1 detected by the robot current position detection unit 62, the system 60 forms a teaching path, and stores the formed teaching path on the teaching path database 63. Then, based on the current position of the robot 1 detected by the robot current position detection unit 62, the path of the human 102 stored on the path database 64, and the teaching path stored on the teaching path database 63, the system 60 forms a tracking path relative to the human 102 and moves the robot 1 by drive-controlling the drive unit 10 by the control unit 50 so that the robot 1 moves along the tracking path formed.

More specific explanation of the movement of the robot 1 will be given below.

(1) The robot 1 detects the relative position of the traveling path of the robot 1 and the current operator 102 by image-picking-up the relative position with the omnidirectional optical system 32a, generates the path through which the human 102 who is the operator moves, and saves the generated path on the path database 64 (FIG. 6B).

(2) The path of the operator 102 saved on the path database 64 is compared with the current path of the robot 1 so as to determine the traveling direction (moving direction) of the robot 1. Based on the traveling direction (moving direction) of the robot 1 determined, the drive unit 10 is drive-controlled by the control unit 50, whereby the robot 1 follows the human 102.

As described above, a method, in which the robot 1 follows the human 102, positional information at the time of the robot moving is accumulated on the basic path teaching data storage unit 34, and the basic path teaching data is created by the movable area calculation unit 35 based on the accumulated positional information, and the drive unit 10 is drive-controlled by the control unit 50 based on the basic path teaching data created so that the robot 1 autonomously moves along the basic path 104, is called a “playback-type navigation”.

When describing the content of the playback-type navigation again, the robot 1 moves so as to follow a human, and the robot 1 learns the basic path 10 through which the robot 1 is capable of moving safely, and when the robot 1 autonomously moves, the robot 1 performs playback autonomous movement along the basic path 104 the robot 1 has learned.

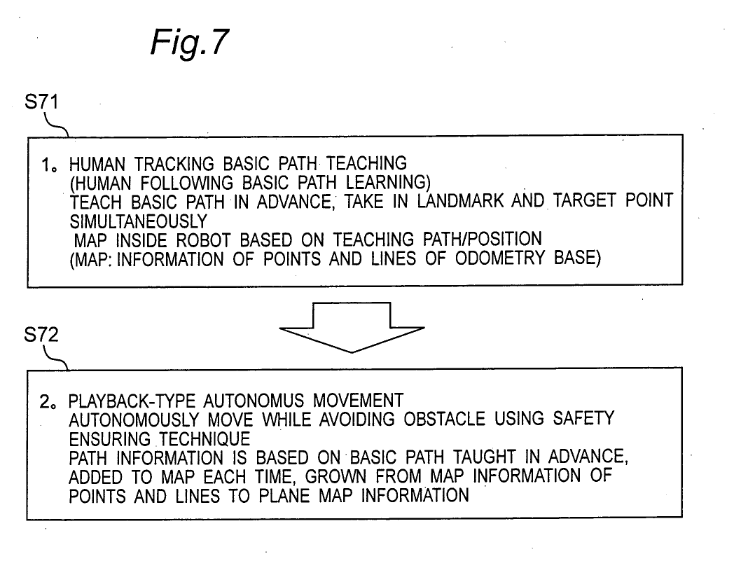

As shown in the operational flow of the playback-type navigation of FIG. 7, operation of the playback-type navigation is composed of two steps S71 and S72.

The first step S71 is a step of teaching a basic path following a human. In step S71, the human 102 teaches a basic path to the robot 1 before the robot 1 autonomously moves, and at the same time, peripheral landmarks and target points when the robot 1 moves are also taken in and stored on the basic path teaching data storage unit 34 from the omnidirectional camera 32a. Then, based on the teaching path/positional information stored on the basic path teaching data storage unit 34, the movable area calculation unit 35 of the robot 1 generates the basic path 104 composed of the map information. The basic path 104 composed of the map information here is formed by information of odometry-based points and lines obtained from the drive unit 10.

The second step S72 is a step of playback-type autonomous movement. In step S72, the robot 1 autonomously moves while avoiding the obstacle 103 by using a safety ensuring technique (for example, a technique for drive-controlling the drive unit 10 by the control unit 50 such that the robot 1 moves a path that the obstacle 103 and the robot 1 will not contact each other and which is spaced apart at a distance sufficient for the safety from the position where the obstacle 103 is detected, in order not to contact the obstacle 103 detected by the obstacle detection unit 36). Based on information of the basic path 104 stored on the basic path teaching data storage unit 34 which is taught by the human 102 to the robot 1 before the robot 1 autonomously moves, in the path information at the time of the robot 1 moving (for example, path change information that the robot 1 newly avoided the obstacle 103), each time additional path information is newly generated by the movable area calculation unit 35 since the robot 1 avoids the obstacle 103 or the like, the additional path information is added to the map information stored on the basic path teaching data storage unit 34. In this way, the robot 1 makes the map information of points and lines (basic path 104 composed of points and lines) to be grown as map information of a plane (path within movable area in which movable area (additional path information) 104a in the width direction (direction orthogonal to the robot moving direction) is added with respect to the basic path composed of points and lines), while moving the basic path 104, and then stores the grown planar map information on the basic path teaching data storage unit 34.

The two steps S71 and S72 will be described below in detail.

(Step S71, that is, Human-Tracking Basic Path Teaching (Human-Following Basic Path Learning))

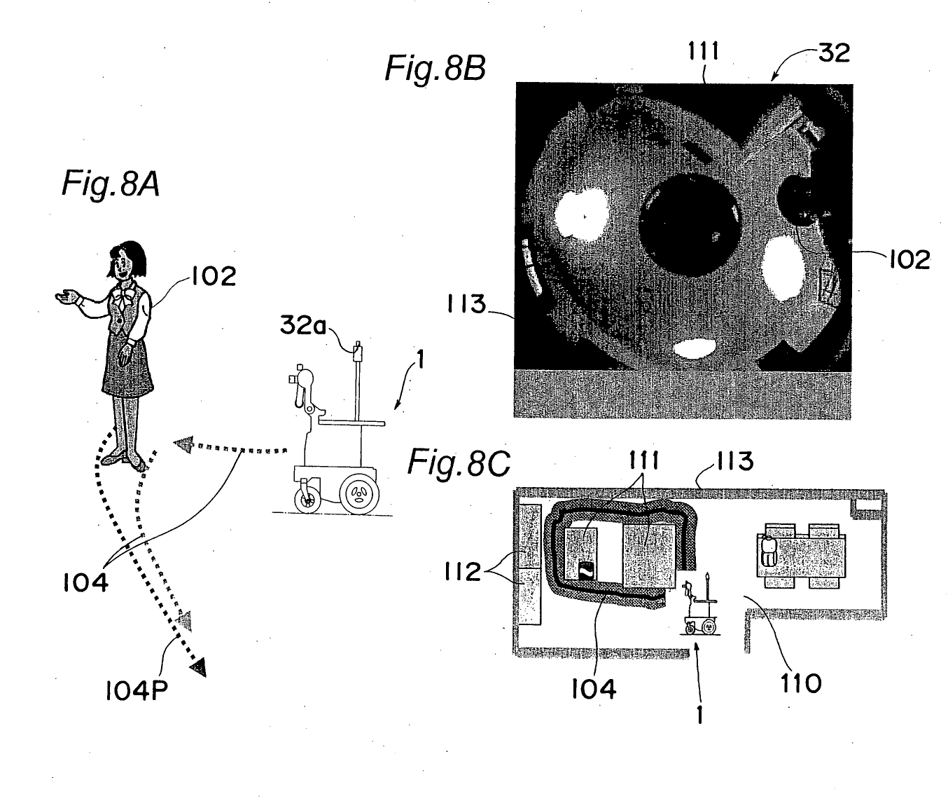

FIGS. 8A to 8C show a step of teaching a human-following basic path. The human 102 teaches the basic path 104 to the robot 1 before the robot 1 autonomously moves, and at the same time, peripheral landmarks and target points when the robot 1 moves are also taken in and stored on the basic path teaching data storage unit 34 from the omnidirectional camera 32a. Teaching of the basic path 104 is performed such that the human 102 walks through a safe path 104P not to contact desks 111, shelves 112, a wall surface 113, and the like inside a room 110, for example, and thus, causes the robot 1 to move following the human 102. That is, the control unit 50 controls the drive unit 10 so as to move the robot 1 such that the human 102 is always located at a certain part of the omnidirectional camera 32a. In this way, respective robot odometry information (for example, information of the number of rotations of the left-side drive wheel 100 from the left-side encoder 21 and information of the number of rotations of the right-side drive wheel 100 from the right-side encoder 22) is totalized on the basic path teaching data storage unit 34 from the drive unit 10 respectively, and is stored as information of each moving distance. Based on the teaching path/positional information stored on the basic path teaching data storage unit 34, the movable area calculation unit 35 of the robot 1 generates the basic path 104 composed of the map information. The basic path 104 composed of the map information here is formed by information of odometry-based points and lines.

The human-tracking basic path teaching uses human position detection performed by the omnidirectional camera 32a. First, the human 102 is detected by extracting the direction of the human 102 approaching the robot 1, viewed from the robot 1, from an image of the omnidirectional camera 32a, and extracting an image corresponding to the human, and the front part of the robot 1 is directed to the human 102. Next, by using the stereo cameras 31a and 31b, the robot 1 follows the human 102 while detecting the direction of the human 102 viewed from the robot 1 and the depth between the robot 1 and the human 102. In other words, for example, the robot 1 follows the human 102 while controlling the drive unit 10 of the robot 1 by the control unit 50 such that the human 102 is always located in a predetermined area of the image obtained by the stereo cameras 31a and 31b and the distance (depth) between the robot 1 and the human 102 always falls in an allowable area (for example, an area of a certain distance that the human 102 will not contact the robot 1 and the human 102 will not go off the camera image). Further, at the time of basic path teaching, the allowable width (movable area 104a) of the basic path 104 is detected by the obstacle detection unit 36 such as an ultrasonic sensor.

As shown in FIGS. 9A and 9B, the full-view of the ceiling 114 of the room 110 is taken in the memory 51 by the omnidirectional camera 32a time-sequentially while learning the human-following basic path. This is saved together with odometry information of the position when taking in the image.

(Step S72, that is, Playback-Type Autonomous Movement)

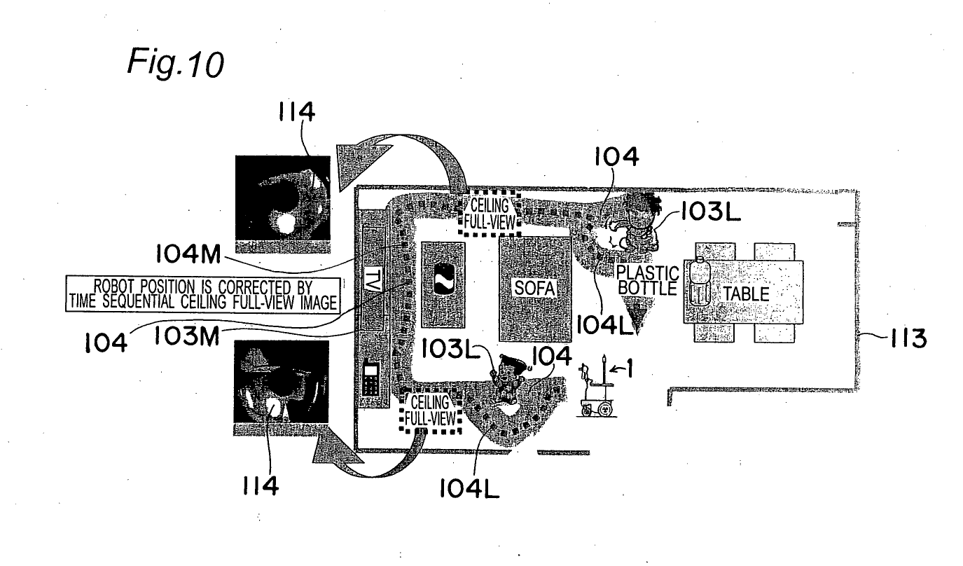

FIG. 10 shows autonomous movement of the playback-type robot 1. By using the safety ensuring technique, the robot 1 autonomously moves while avoiding the obstacle 103. Path information at each movement is based on information of the basic path 104 which is taught by the human 102 to the robot 1 before autonomous movement of the robot 1 and stored on the basic path teaching data storage unit 34, and as for path information of the robot 1 when moving (for example, path change information that the robot 1 newly avoids the obstacle 103), each time additional path information is newly generated by the movable area calculation unit 35 since the robot 1 avoids the obstacle 103 or the like, the additional path information is added to the map information stored on the basic path teaching data storage unit 34. In this way, the robot 1 makes the map information of points and lines (basic path 104 composed of points and lines) to be grown as map information of a plane (path within movable area in which movable area (additional path information) 104a in the width direction (direction orthogonal to the robot moving direction) is added with respect to the basic path 104 composed of points and lines), while moving the basic path 104, and then stores the grown map information onto the basic path teaching data storage unit 34.

For positional correction of the robot 1 when moving autonomously, a ceiling full-view time-sequential image and odometry information, obtained at the same time as teaching the human-following basic path, are used. When the obstacle 103 is detected by the obstacle detection unit 36, the movable area calculation unit 35 calculates the path locally and generates the path by the moving path generation unit 37, and the control unit 50 controls the drive unit 10 such that the robot 1 moves along the local path 104L generated so as to avoid the obstacle 103 detected, and then the robot 1 returns to the original basic path 104. If a plurality of paths are generated when calculating and generating the local path by the movable area calculation unit 35 and the moving path generation unit 37, the moving path generation unit 37 selects the shortest path. Path information when an avoidance path is calculated and generated locally (path information for local path 104L) is added to the basic path (map) information of step S71 stored on the basic path teaching data storage unit 34. Thereby, the robot 1 makes the map information of points and lines (basic path 104 composed of points and lines) to be grown as map information of a plane (path within movable area in which movable area (additional path information) 104a in the width direction (direction orthogonal to the robot moving direction) is added with respect to the basic path 104 composed of points and lines), while moving the basic path 104 autonomously, and then stores the grown map information onto the basic path teaching data storage unit 34. At this time, for example, if the obstacle 103 detected is a human 103L such as a baby or an elderly person, he/she may further moves around the detected position unexpectedly, so it is desirable to generate the local path 104L so as to bypass largely. Further, considering a case where the robot 1 carries liquid or the like, when the robot 1 moves near a precision apparatus 103M such as a television which is subject to damage if the liquid or the like is dropped accidentally, it is desirable to generate a local path 104M such that the robot 1 moves so as to curve slightly apart from the periphery of the precision apparatus 103M.

According to the first embodiment, the human 102 walks the basic path 104 and the robot 1 moves the basic path 104 following the human 102, whereby when the basic path 104 is taught to the robot 1 and then the robot 1 autonomously moves along the basic path 104 taught, a movable area for avoiding the obstacle 103 or the like is calculated, and with the basic path 104 and the movable area, it is possible to generate a moving path 106 that the robot 1 can autonomously move actually.

As a scene for putting the robot 1 described above into practice, there may be a case where a robot carries baggage inside the house, for example. The robot waits at the entrance of the house, and when a person who is an operator comes back, the robot receives baggage from the person, and at the same time, the robot recognizes the person who put on the baggage, as a following object, and the robot follows the person while carrying the baggage. At this time, in the moving path of the robot in the house, there may be a number of obstacles, different from a public place. However, the robot of the first embodiment having a means for avoiding obstacles can avoid the obstacles by following the moving path of the person. This means that the path that the robot 1 of the first embodiment uses as a moving path is a moving path that the human 102 who is the operator has walked right before, so possibility of obstacles being present is low. If an obstacle appears after the human 102 has passed, the obstacle detection unit 36 mounted on the robot 1 detects the obstacle, so the robot 1 can avoid the detected obstacle.

### Second Embodiment

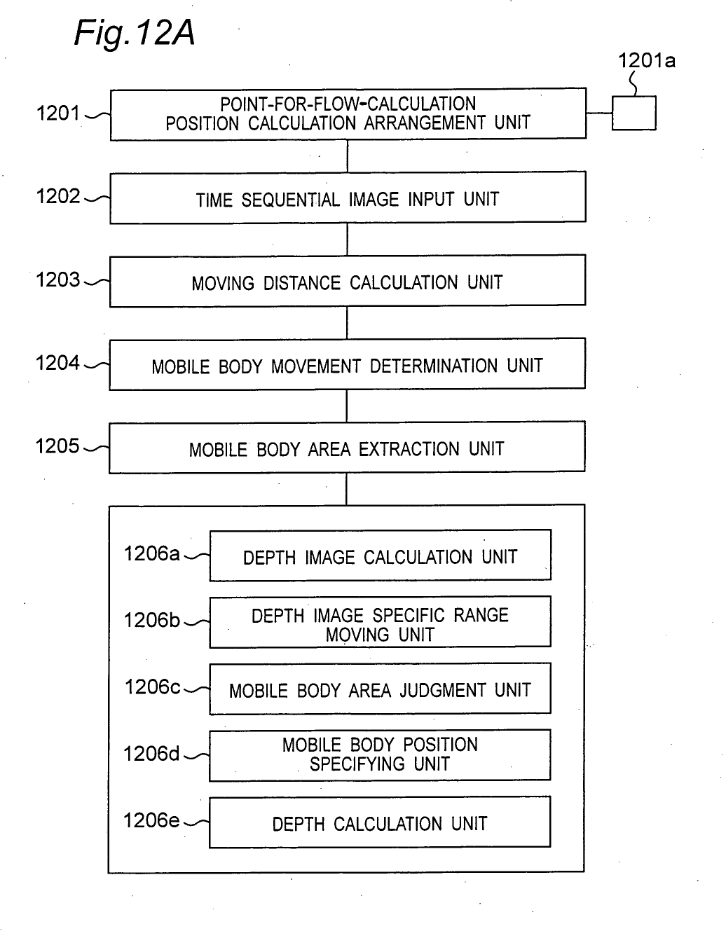

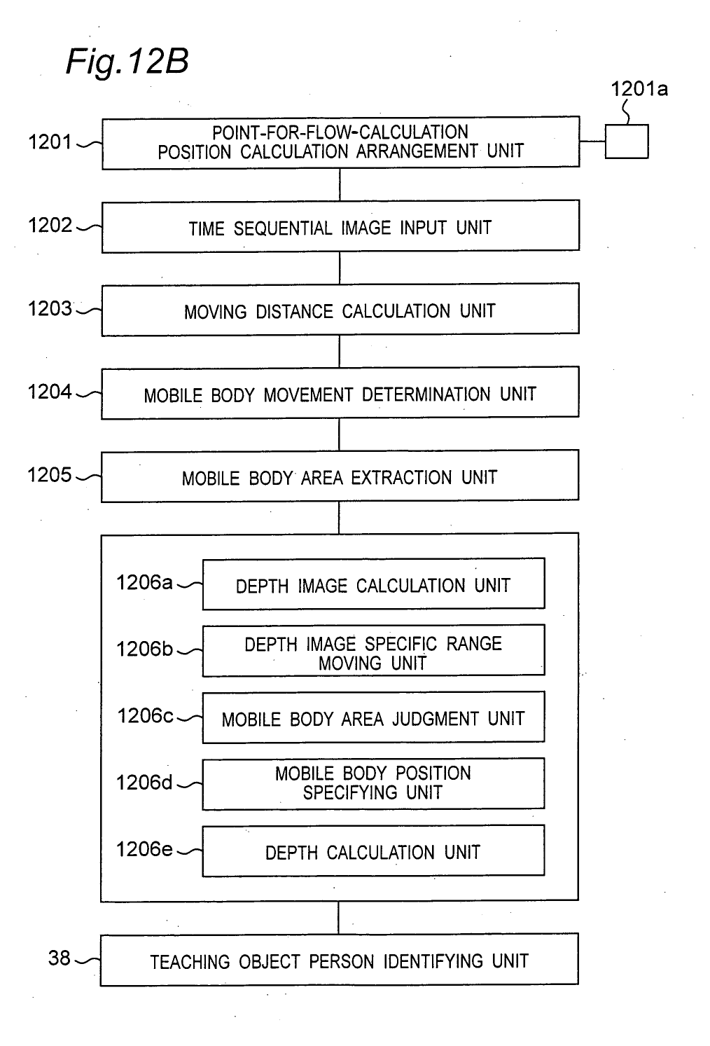

Next, in a robot control apparatus and a robot control method according to a second embodiment of the present invention, a mobile body detection device (corresponding to the human-moving detection unit 31) for detecting a mobile body and a mobile body detection method will be explained in detail with reference to FIGS. 12A to 18D. Note that a “mobile body” mentioned here means a human, an animal, an apparatus moving automatically (autonomously mobile robot, autonomous travel-type cleaner, etc.), or the like. Further, a mobile body detection device 1200 is newly added to the robot control apparatus according to the first embodiment (see FIG. 1A), but the components of a part thereof may also work as components of the robot control apparatus according to the first embodiment.

The mobile body detection device and the mobile body detection method use an optical flow.

Before explaining the mobile body detection device and the mobile body detection method, explanation of the optical flow will be shown in FIG. 13.

As shown in corresponding points 201 in FIG. 13, in the optical flow, corresponding points 201 for calculating a flow are arranged in a lattice-point shape all over the screen of the processing object, and points corresponding to the respective corresponding points 201 are detected on a plurality of images continuing time-sequentially, and the moving distances between the points corresponding to the respective points 201 are detected, whereby a flow of each corresponding point 201 is obtained, generally. Therefore, the corresponding points 201 are arranged in a lattice-point shape all over the screen at equal intervals, and since flow calculation is performed for each corresponding point 201, the calculation amount becomes enormous. Further, as the number of corresponding point 201 becomes larger, a possibility of detecting a noise flow increases, whereby erroneous detection may be caused easily.

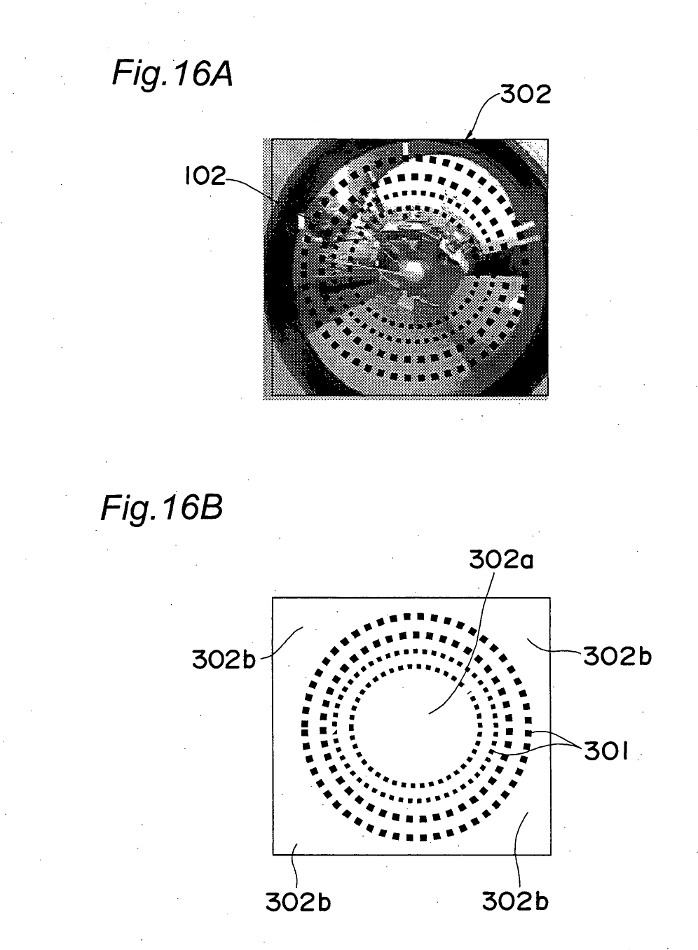

When the omnidirectional optical system 32a is used, as shown in an illustration view of corresponding points of FIG. 16B in which only corresponding points are extracted from the omnidirectional camera image 302 and the omnidirectional camera image 302 in FIG. 16A, a flow (noise flow) other than an optical flow may be generated easily due to movement of a human and an object at corresponding points 301 in the image center part constituting a foot (near floor) area 302a of the human 102, and at corresponding points 301 in the four corner areas 302b of the image which are out of sight of the omnidirectional camera.

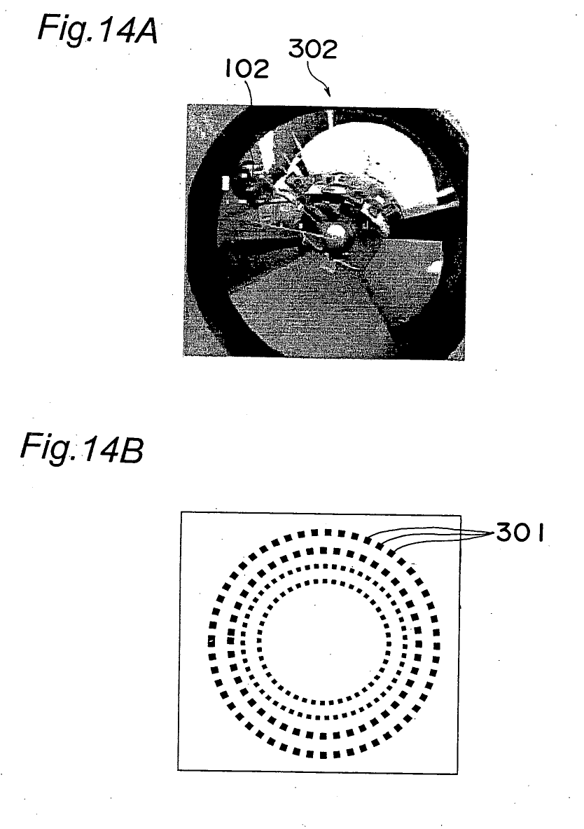

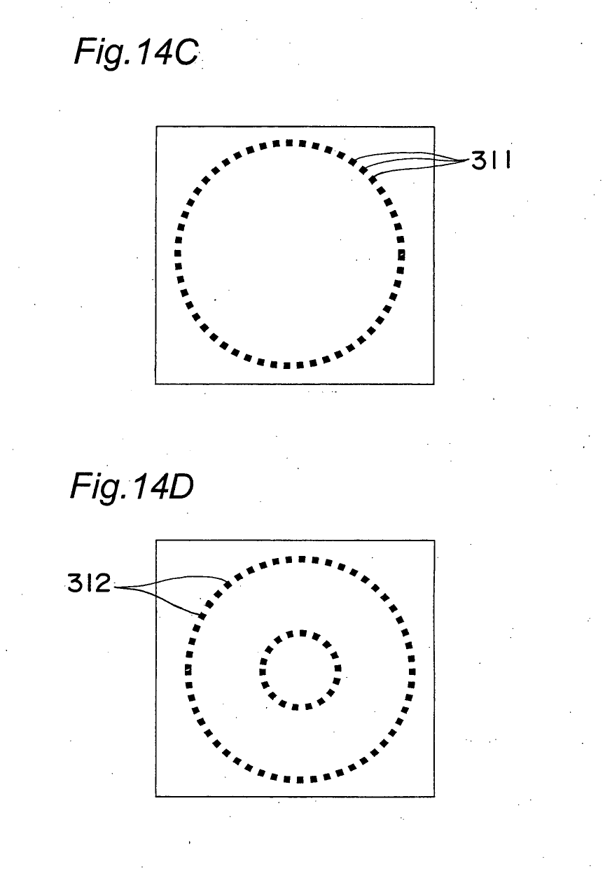

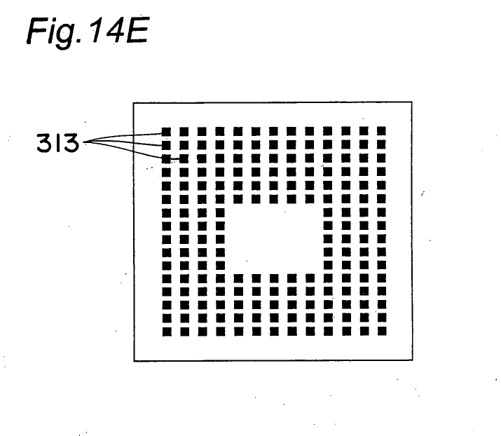

In view of the above, in the mobile body detection device and the mobile body detection method of the robot control apparatus and the robot control method according to the second embodiment of the present invention, an area in which corresponding points (points-for-flow-calculation) 301 are arranged is limited to a specific area of the mobile body approaching the robot 1, without arranging all over the screen area equally, so as to reduce the calculation amount and the calculation cost. FIG. 14A shows an actual example of an image when an omnidirectional camera is used as an example of the omnidirectional optical system 32a, an FIGS. 14B to 14E show various examples of arrangements of corresponding points with respect to the image.

In the case of an omnidirectional camera image 302 picked-up by using an omnidirectional camera (FIG. 14A), a human 102 appears on the outer circle's perimeter of the image 302. Therefore, corresponding points 301 of FIG. 14B are arranged on the outer circle's perimeter of the image 302. As a specific example, in the case of an omnidirectional camera image of 256*256 pixel size, the corresponding points 301 are arranged at intervals of about 16 pixels on the outer circle's perimeter of the omnidirectional camera image. Further, feet and the like of the human 102 appear on the inner circle's perimeter of the omnidirectional camera image 302, and a noise flow inappropriate for positional detection may appear easily. Further, in the case of the omnidirectional camera image 302, the four corners of the omnidirectional camera image 302 are out of significant area of the image, so flow calculation of the corresponding points is not required. Accordingly, it is advantageous for both the calculation cost and the countermeasures against noise by arranging the flow corresponding points 301 on the outer circle's perimeter of the omnidirectional camera image 302 and not arranging the flow corresponding points 301 on the inner circle's perimeter, as shown in FIG. 14B.

Further, as shown in FIG. 14C, when detecting a human 102 by limiting to the human 102 approaching the robot 1, flow corresponding points 311 may be arranged only on the outermost circle's perimeter of the omnidirectional camera image 302.

Further, as shown in FIG. 14D, when detecting both an approach of the human 102 and an approach of an obstacle 103, flow corresponding points 312 may be arranged only on the outermost circle's perimeter and the innermost circle's perimeter of the omnidirectional camera image 302.

Further, as shown in FIG. 14E, flow corresponding points 313 may be arrange in a lattice shape at equal intervals in an x direction (lateral direction in FIG. 14E) and a y direction (longitudinal direction in FIG. 14E) of the omnidirectional camera image 302 for high-speed calculation. As a specific example, in the case of an omnidirectional camera image of 256*256 pixel size, flow corresponding points 313 are arranged at intervals of 16 pixels in the x direction and 16 pixels in the y direction of the omnidirectional camera image.

As shown in FIG. 12A, the mobile body direction device 1200 for performing the mobile body detection method according to the second embodiment is configured to include a point-for-flow-calculation position calculation arrangement unit 1201, a time sequential image input unit 1202, a moving distance calculation unit 1203, a mobile body movement determination unit 1204, a mobile body area extraction unit 1205, a depth image calculation unit 1206a, a depth image specific area moving unit 1206b, a mobile body area judgment unit 1206c, a mobile body position specifying unit 1206d, a depth calculation unit 1206e, and a memory 51.

In a case of omnidirectional time sequential images in which the omnidirectional camera images 302 shown in FIG. 14A picked-up by an omnidirectional camera which is an example of the omnidirectional optical system 32a are taken into the memory 51 time-sequentially, the point-for-flow-calculation position calculation arrangement unit 1201 calculates positions of the significant corresponding points 301, 311, 312, or 313 on the circle's perimeter of the omnidirectional time sequential image as shown in FIG. 14B, 14C, 14D, or 14E. The point-for-flow-calculation position calculation arrangement unit 1201 may further include a corresponding point position calculation arrangement changing unit 1201a, and (point-for-flow-calculation) corresponding point positions which are calculated, arranged, and detected (flow calculation) in advance according to the movement of the mobile body, for example, a human 102, may be changed in each case by the corresponding point position calculation arrangement changing unit 1201a according to the position of the mobile body, for example, the human 102. With this configuration, it becomes more advantageous for the calculation cost and the countermeasures against noise. Further, for each of the corresponding points 301, 311, 312, or 313 of the point-for-flow-calculation position calculated by the point-for-flow-calculation position calculation arrangement unit 1021, an optical flow is calculated by the moving distance calculation unit 1203.

The time sequential image input unit 1202 takes in images at appropriate time intervals for optical flow calculation. For example, the omnidirectional camera image 302 picked-up by the omnidirectional camera is inputted and stored on the memory 51 by the time sequential image input unit 1202 for each several 100 ms. When using the omnidirectional camera image 302 picked-up by the omnidirectional camera, a mobile body approaching the robot 1 is detectable in a range of 360 degrees around the robot 1, so there is no need to move or rotate the camera for detecting the mobile body so as to detect the approaching mobile body. Further, even when an approaching mobile body (e.g., a person teaching the basic path) which is a tracking object without time delay approaches the robot 1 from any direction, detecting of the mobile body is possible easily and surely.

The moving distance calculation unit 1203 detects positioning relationship of the corresponding points 301, 311, 312, or 313 between time sequential images obtained by the time sequential image input unit 1202 for each of the corresponding points 301, 311, 312, or 313 calculated by the point-for-flow-calculation position calculation arrangement unit 1201. Generally, a corresponding point block composed of corresponding points 301, 311, 312, or 313 of the old time sequential image is used as a template, and template matching is performed on a new time sequential image of the time sequential images. Information of coincident points obtained in the template matching and displacement information of the corresponding point block position of the older image are calculated as a flow. The coincidence level or the like at the time of template matching is also calculated as flow calculation information.

The mobile body movement determination unit 1204 determines whether the calculation moving distance coincides with the movement of the mobile body for each of the corresponding points 301, 311, 312, or 313. More specifically, the mobile body movement determination unit determines whether the mobile body has moved, by using displacement information of the corresponding point block position, flow calculation information, and the like. In this case, if the same determination criteria are used for all screens, in a case of a foot and the head of a human which is an example of a mobile body, a possibility of detecting the human's foot as a flow becomes high. Actually, however, it is necessary to flow-detect the head of a human preferentially. Therefore, in the second embodiment, different criteria for determination are used for the respective corresponding points 301, 311, 312, or 313 arranged by the point-for-flow-calculation position calculation arrangement unit 1201. As an actual example, as flow determination criteria of an omnidirectional camera image, flows in radial direction remain inside the omnidirectional camera image (as a specific example, inside from ¼ of the radius (lateral image size) from the center of the omnidirectional camera image), and the both directional flows which are in the radial direction and concentric circle direction remain outside the omnidirectional camera image (as a specific example, outside from ¼ of the radius (lateral image size) from the center of the omnidirectional camera image).

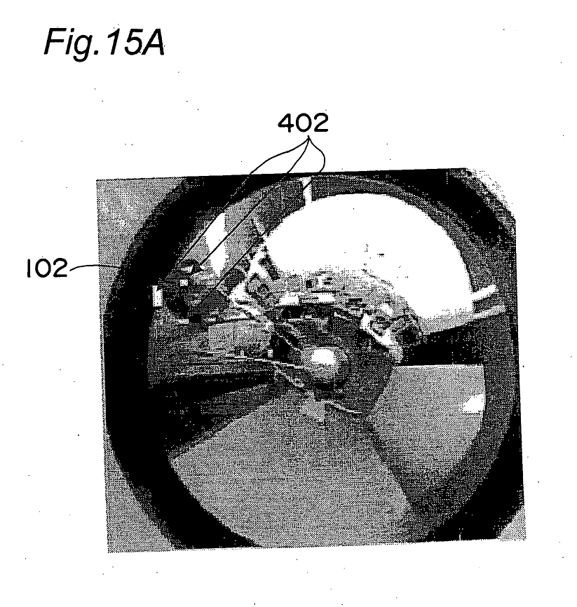

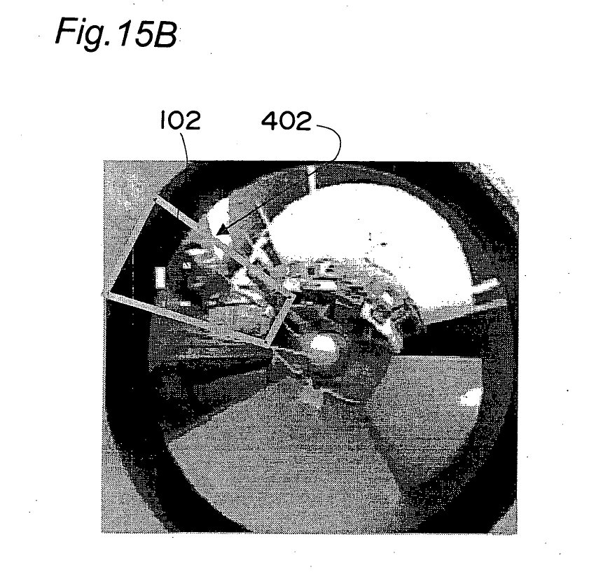

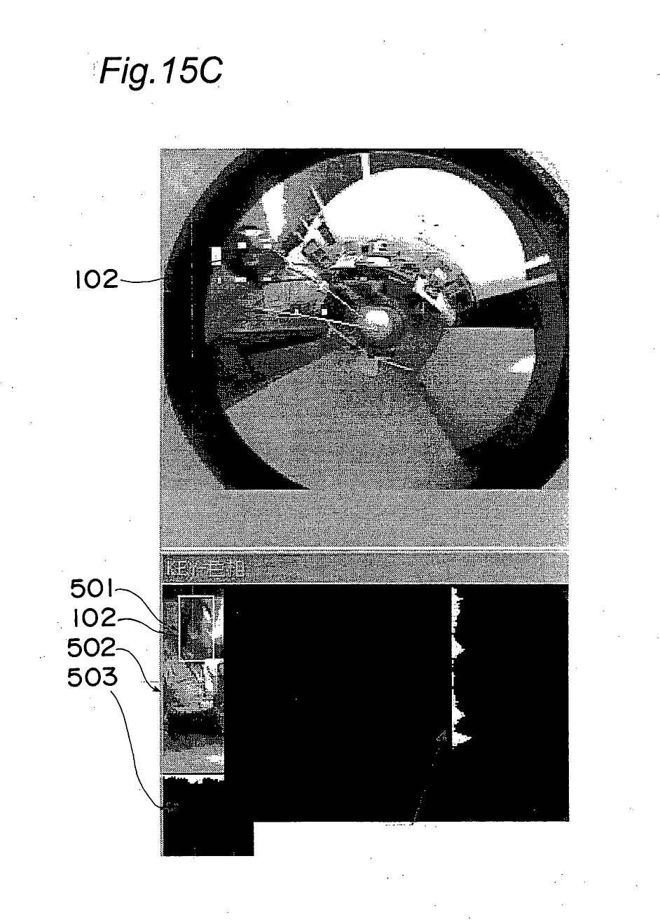

The mobile body area extraction unit 1205 extracts a mobile body area by unifying a group of corresponding points coincided. That is, the mobile body area extraction unit 1205 unifies flow corresponding points accepted by the mobile body movement determination unit 1204 for determining whether the calculated moving distance coincides with the movement of the mobile body for each corresponding point, and then extracts the unified flow corresponding points as a mobile body area. As shown in FIG. 15A, an area surrounding a group of corresponding points 401 accepted by the mobile body movement determination unit 1204 is extracted by the mobile body area extraction unit 1205. As shown in FIG. 15B, a trapezoid area surrounded by the reference numeral 402 is an example of the mobile body area (a human area in the case of a human as an example of the mobile body) extracted. Note that FIG. 15C is an illustration view showing a result where a human area panoramic development image 502 of the human 102 is used, and the head is extracted from a specific gray value projected image of the human area panoramic development image 502 (longitudinal direction is shown by 503 and lateral direction is shown by 504). The area where the head is extracted is shown by the reference numeral 501.

The depth image calculation unit 1206a calculates a depth image in a specific area (depth image specific area) around the robot 1. The depth image is an image in which those nearer the robot 1 in distance are expressed brighter. The specific area is set in advance to a range of, for example, ±30° relative to the front of the robot 1 (determined by experience value, changeable depending on sensitivity of the sensor or the like).

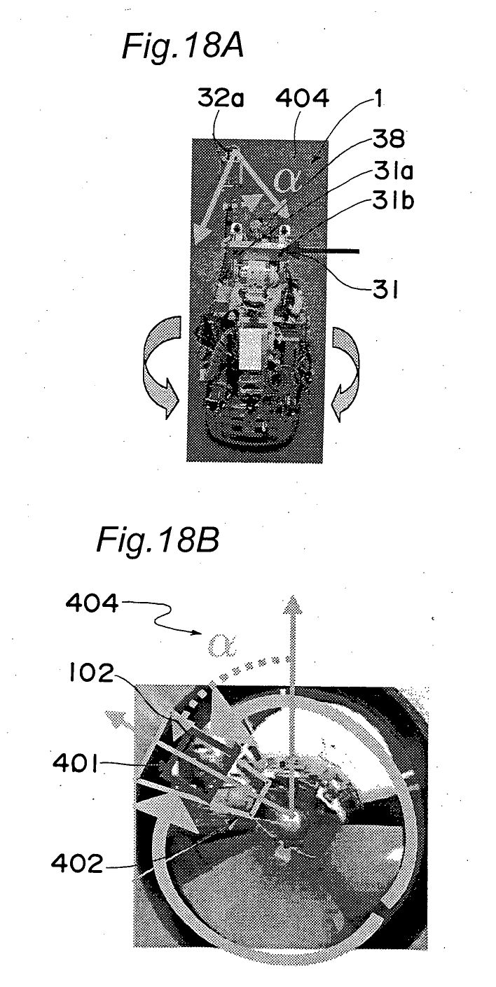

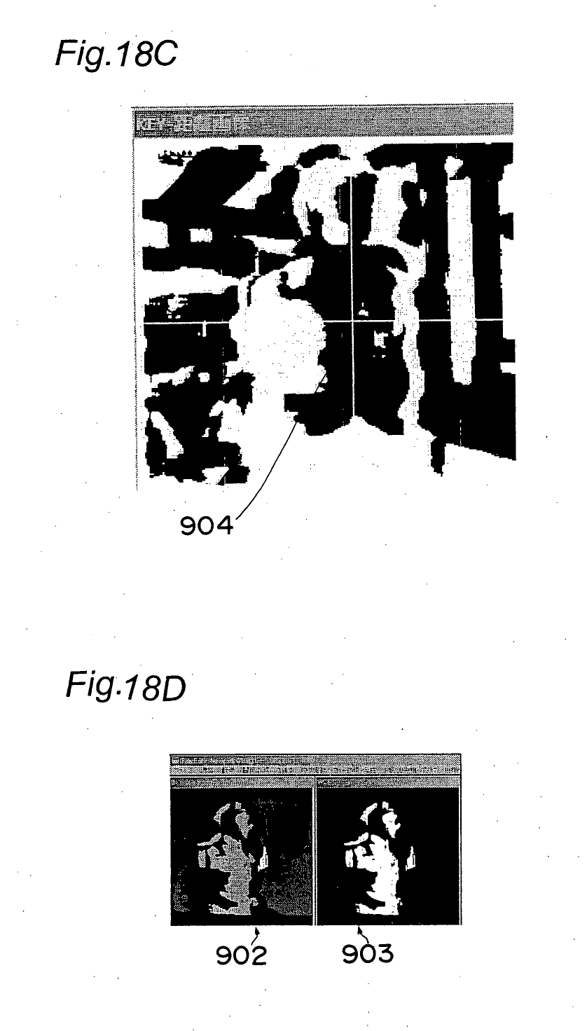

The depth image specific area moving unit 1206b moves the depth image specific area according to the movement of the area of the human area 402 such that the depth image specific area corresponds to the area of the human area 402 as an example of the mobile body area extracted by the mobile body area extraction unit 1205. More specifically, as shown in FIGS. 18A to 18D, by calculating an angle between the line linking the center of the human area 402 surrounding the group of corresponding points 401 and the center of the image and the front direction of the robot 1 of FIG. 18A by the depth image specific area moving unit 1206b, a directional angle a (the front direction of the robot 1 in FIG. 18A can be set as the reference angle 0° of the directional angle) of the human 102 of the reference numeral 404 in FIG. 18A is calculated. Corresponding to the calculated angle (directional angle) a, the depth image in the specific area (depth image specific area) around the robot 1 is moved so as to conform the depth image specific area to the area of the human area 402. In order to move the depth image specific area so as to conform to the area of the human area 402 in this way, specifically, the both drive wheels 100 are rotated in reverse to each other by the drive unit 10, and the direction of the robot 1 is rotated by the angle (directional angle) a at the position so as to conform the depth image specific area to the area of the human area 402 extracted. Thereby, the detected human 102 can be positioned in front of the robot 1 within the depth image specific area, in other words, within the area capable of being picked-up by the stereo camera system 31a and 31b which is an example of a depth image detection sensor constituting a part of the depth image calculation unit.

The mobile body area judgment unit 1206c judges the mobile body area within the depth image specific area after moved by the depth image calculation unit 1206a. For example, the image of the largest area among the gray images within the depth image specific area is judged as a mobile body area.

The mobile body position specifying unit 1206d specifies the position of the mobile body, for example, a human 102 from the depth image mobile body area obtained. As a specific example specifying the position of the human 102, the position of the human 102 can be specified by calculating the gravity position of the human area (an intersection point 904 of the cross lines in FIG. 18C) as the position and the direction of the human 102, in FIG. 18C.

The depth calculation unit 1206e calculates the distance from the robot 1 to the human 102 based on the position of the mobile body, for example, the human 102 on the depth image.

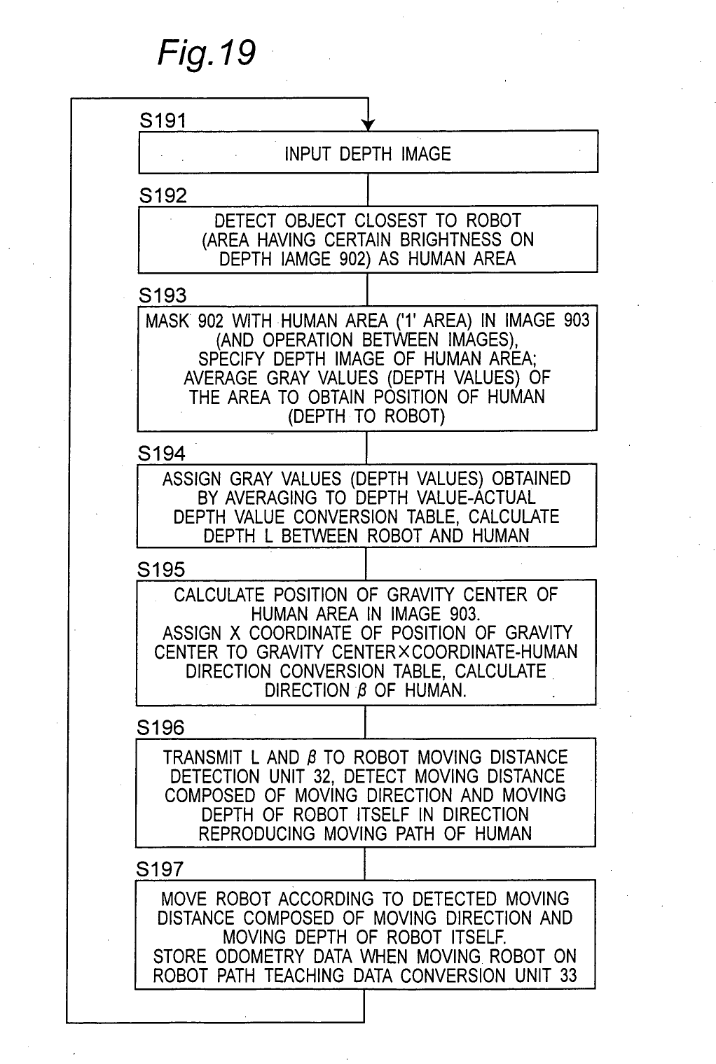

Explanation will be given for performing mobile body detecting operation by using the mobile body detection unit 1200 according to the above-described configuration with reference to FIGS. 18A to 19 and the like.

First, in step S191, a depth image is inputted into the depth image calculation unit 1206a. Specifically, the following operation is performed. In FIG. 18A, a specific example of the depth image calculation unit 1206a can be configured of a depth image detection sensor for calculating a depth image in a specific area (depth image specific area) around the robot 1 and a depth image calculation unit for calculating the depth image detected by the depth image detection sensor. By the mobile body movement determination unit 1204 and the directional angle 404 of the human 102 and the depth image specific area moving unit 1206b, the human 102 is assumed to be positioned within the specific area around the robot 1. When the stereo cameras 31a and 31b of the parallel optical axes are used as an example of the depth image detection sensor, the corresponding points of the right and left stereo cameras 31a and 31b appear on the same scan line, whereby high-speed corresponding point detection and three-dimensional depth calculation can be performed by the depth image calculation unit 1206a. In FIG. 18D, a depth image which is the result of corresponding point detection of the right and left stereo cameras 31a and 31b and three-dimensional depth calculation result by the depth image calculation unit 1206a is shown by the reference numeral 902. In the depth image 902, the stereo cameras 31a and 31b express those nearer in distance to the robot 1 brighter.

Next, in step S192, the object nearest to the robot 1 (in other words, an area having certain brightness (brightness exceeding a predetermined threshold) on the depth image 902) is detected as a human area. An image in which the detection result is binarized is an image 903 of FIG. 18D detected as the human area.

Next, in step S193, the depth calculation unit 1206e masks the depth image 902 with the human area (when a gray image is binarized with “0” and “1”, an area of “1” corresponding to an area with a human) of the image 903 detected as the human area in FIG. 18D (AND operation between images), and the depth image of the human area is specified by the depth calculation unit 1206e. The distances (depths) of the human area (gray values of the human area (depth values)) are averaged by the depth calculation unit 1206e, which is set as the position of the human 102 (depth between the robot 1 and the human 102).

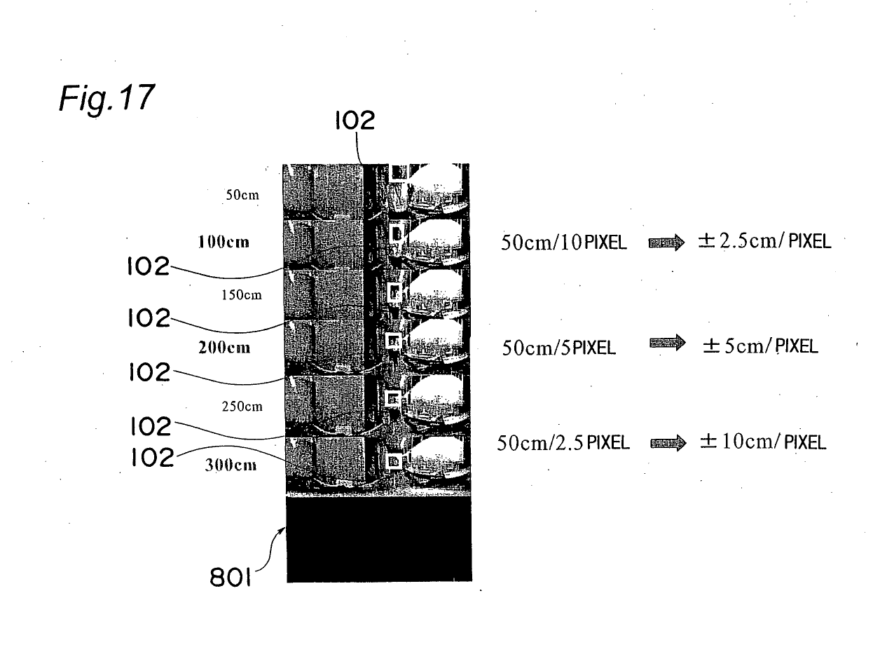

Next, in step S194, the gray value (depth value) obtained by being averaged as described above is assigned to a depth value-actual depth value conversion table of the depth calculation unit 1206e, and the distance (depth) L between the robot 1 and the human 102 is calculated by the depth calculation unit 1206e. An example of the depth value-actual depth value conversion table is, in an image 801 in which panoramic development images of the omnidirectional camera images having different depths to the human 102 are aligned in FIG. 17, when the depth between the robot 1 and the human 102 is 100 cm, it is ±2.5 cm/pixel if 50 cm/10 pixels, when the depth is 200 cm, it is ±5 cm/pixel if 50 cm/5 pixels, and when the depth is 300 cm, it is ±10 cm/pixel if 50 cm/2.5 pixels.

Next, in step S195, the position of the gravity center of the human area of the image 903 is calculated by the mobile body position specifying unit 1206d. The x coordinate of the position of the gravity center is assigned to a gravity center x coordinate-human direction conversion table of the mobile body position specifying unit 1206d, and the direction β of the human is calculated by the mobile body position specifying unit 1206d.

Next, in step S196, the depth L between the robot 1 and the human 102 and the direction β of the human are transmitted to the robot moving distance detection unit 32 of the control device of the first embodiment, and the moving distance composed of the moving direction and the moving depth of the robot 1 is detected in a direction where the moving path of the human 102 is reproduced.

Next, in step S197, the robot 1 is moved according to the detected moving distance composed of the moving direction and the moving depth of the robot 1. Odometry data at the time of moving the robot is stored on the robot basic path teaching data conversion unit 33.

By repeating calculation of steps 191 to 197 as described above, it is possible to specify the human 102 and detect the depth L between the robot 1 and the human 102 and the direction p of the human continuously.

Note that as a method of confirming the operation by the human 102 of teaching tracking travel (see 38 in FIG. 1B), based on a knowledge that the human 102 approaching most and contacting the robot 1 is a human-tracking object person (target), a teaching object person identifying unit 38 in the case of a plurality of object persons are present may be incorporated (see FIG. 12B). Specific examples of the teaching object person identifying unit 38 include an example where a switch provided at a specific position of the robot 1 is pressed, and an example where a voice is generated and the position of the sound source is estimated by a voice input device such as a microphone. Alternatively, there is an example in which the human 102 possesses an ID resonance tag or the like, and a reading device capable of reading the ID resonance tag is provided in the robot 1 so as to detect a specific human. Thereby, as shown in FIG. 12B, it is possible to specify the robot tracking object person, and to use as a trigger to start a robot human-tracking operation at the same time.

As described above, in the second embodiment, by detecting depth and direction of the human 102 from the robot 1 with the configuration described above, it is possible to avoid a case where a correct path cannot be generated if the robot 1 follows the position of the human 102 straightly in the tracking travel (see FIGS. 6A and 6B). In a case that only the direction of the human 102 is detected and the path 107a of the human 102 becomes a right angle corner as shown in FIG. 6A for example, the robot 1 may not follow the human 102 at a right angle but might generate a shortcut as the path 107c. In the second embodiment of the present invention, by obtaining direction and depth of the human 102, a control of setting the path 107a of the human 102 of the right angle corner as the path 107d of the robot 1 is to be realized (see FIG. 6B). A procedure of generating such a path 107d will be described below.

(1) The robot 1 looks the relative position between the traveling path of itself and the current operator 102, generates the path 107a of the operator 102, and saves the generated path (FIG. 6B).

(2) The robot 1 compares the saved path 107a of the operator 102 with the current path 107d of the robot 1 itself and determines the traveling direction of the robot 1, and by following the operator 102, the robot 1 can move through the path 107d of the robot 1 along with the path 107a of the operator 102.

According to the above-described configuration of the second embodiment, it is possible to specify a mobile body, for example, a human 102 teaching a path, and to continuously detect the human 102 (e.g., to detect the depth between the robot 1 and the human 102 and the direction of the human 102 viewed from the robot 1).

### Third Embodiment

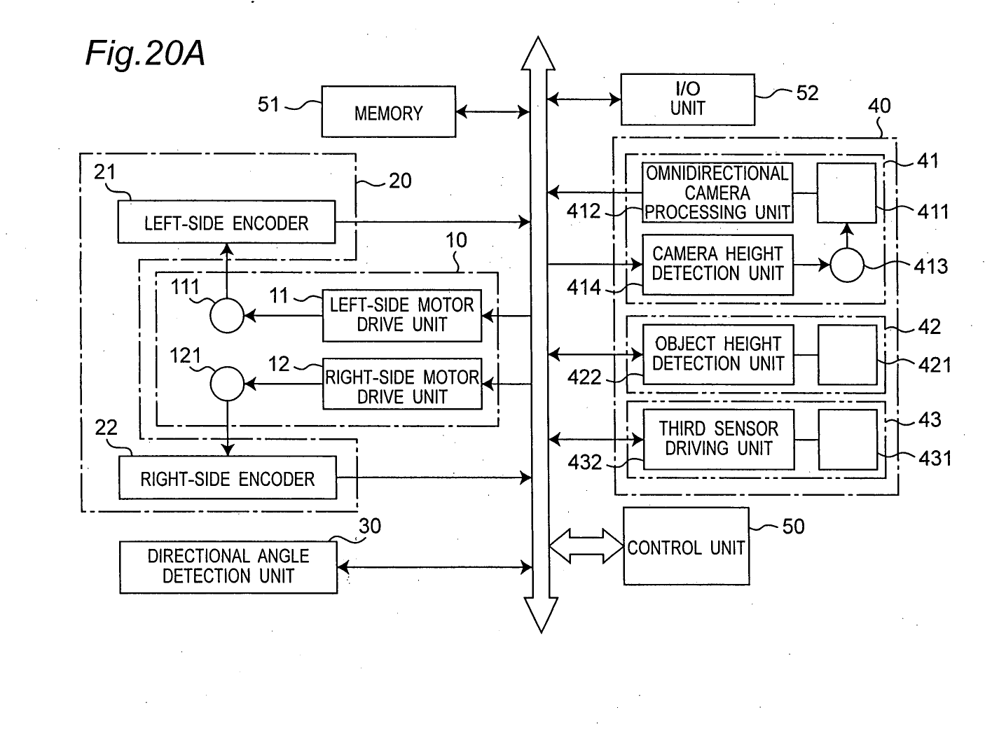

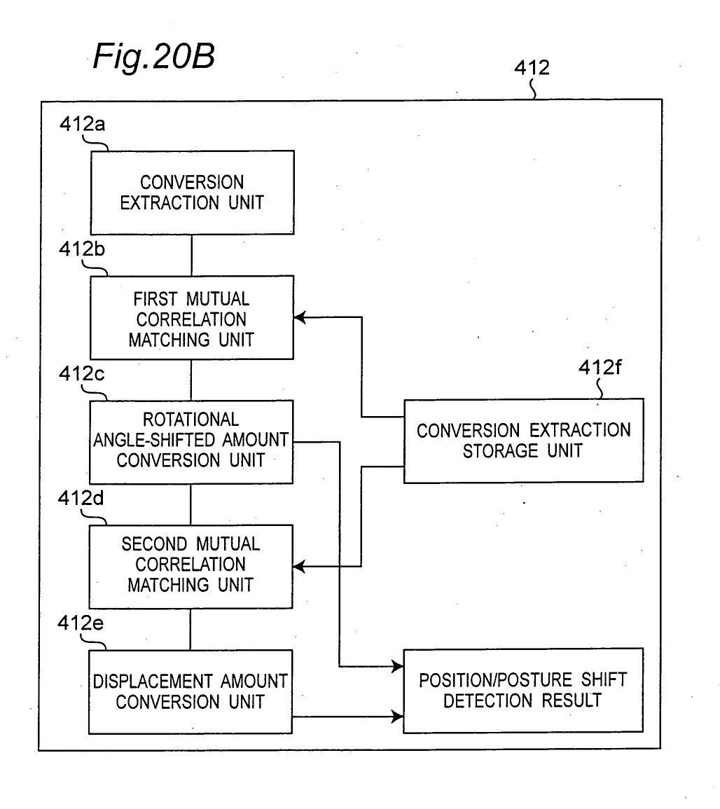

Next, a robot positioning device and a robot positioning method of a robot control apparatus and a robot control method according to a third embodiment of the present invention will be explained in detail with reference to FIGS. 20A to 26. The robot control apparatus according to the third embodiment described below is one newly added to the robot control apparatus according to the first embodiment, and a part of the components is also capable of serving as components of the robot control apparatus according to the first embodiment.

As shown in FIG. 20A, the robot positioning device of the robot control apparatus according to the third embodiment is configured to mainly include the drive unit 10, the travel distance detection unit 20, the directional angle detection unit 30, a displacement information calculation unit 40, and the control unit 50. Note that in FIG. 20A, components such as the movement detection unit 31 through the moving path generation unit 37, the teaching object person identifying unit 38, and the mobile body detection device 1200, and the like, shown in FIG. 1A relating to the robot control apparatus of the first embodiment are omitted. In FIG. 1A, the displacement information calculation unit 40 and the like are also shown in order to show the robot control apparatus according to the first to third embodiments.

The drive unit 10 of the robot control apparatus according to the third embodiment is to control travel in forward and backward directions and movement to the right and left sides of the robot 1 which is an example of an autonomously traveling vehicle, which is same as the drive unit 10 of the robot control apparatus according to the first embodiment. Note that a more specific example of the robot 1 includes an autonomous travel-type vacuum cleaner.

Further, the travel distance detection unit 20 of the robot control apparatus according to the third embodiment is same as the travel distance detection unit 20 of the robot control apparatus according to the first embodiment, which detects travel distance of the robot 1 moved by the drive unit 10.

Further, the directional angle detection unit 30 is to detect the travel directional change of the robot 1 moved by the drive unit 10, same as the directional angle detection unit 30 of the robot control apparatus according to the first embodiment. The directional angle detection unit 30 is a directional angle sensor such as a gyro sensor for detecting travel directional change by detecting the rotational velocity of the robot 1 according to the voltage level which varies at the time of rotation of the robot 1 moved by the drive unit 10.

The displacement information calculation unit 40 is to detect target points up to the ceiling 114 and the wall surface 113 existing on the moving path (basic path 104) of the robot 1 moved by the drive unit 10, and calculating displacement information relative to the target points inputted in the memory 51 in advance from the I/O unit 52 such as a keyboard or a touch panel. The displacement information calculation unit 40 is configured to include an omnidirectional camera unit 41, attached to the robot 1, for detecting target points up to the ceiling 114 and the wall surface 113 existing on the moving path of the robot 1. Note that the I/O unit 52 includes a display device such as a display for displaying necessary information such as target points appropriately, which are confirmed by a human.

The omnidirectional camera unit 41, attached to the robot, of the displacement information calculation unit 40 is configured to include: an omnidirectional camera 411 (corresponding to the omnidirectional camera 32a in FIG. 1B and the like), attached to the robot, for detecting target points up to the ceiling 114 and the wall surface 113 existing on the moving path of the robot 1; an omnidirectional camera processing unit 412 for input-processing an image of the omnidirectional camera 411; a camera height detection unit 414 (e.g., an ultrasonic sensor directed upward) for detecting the height of the omnidirectional camera 411 attached to the robot from the floor 105 on which the robot 1 travels; and an omnidirectional camera height adjusting unit 413 for arranging, in a height adjustable manner (movable upward and downward), the omnidirectional camera 411 fixed to a bracket screwed to a ball screw by rotating the ball screw with a drive of a motor or the like with respect to the column 32b of the robot 1 such that the omnidirectional camera 411 is arranged toward the ceiling 114 and the wall surface 113.

Further, in FIG. 20A, the control unit 50 is a central processing unit (CPU) wherein travel distance data detected by the travel distance detection unit 20 and travel direction data detected by the directional angle detection unit 30 are inputted to the control unit 50 at predetermined time intervals, and the current position of the robot 1 is calculated by the control unit 50. Displacement information with respect to the target points up to the ceiling 114 and the wall surface 113 calculated by the displacement information calculation unit 40 is inputted into the control unit 50, and according to the displacement information result, the control unit 50 controls the drive unit 10 to control the moving path of the robot 1, to thereby control the robot 1 so as to travel to the target points accurately without deviating from the normal track (that is, basic path).

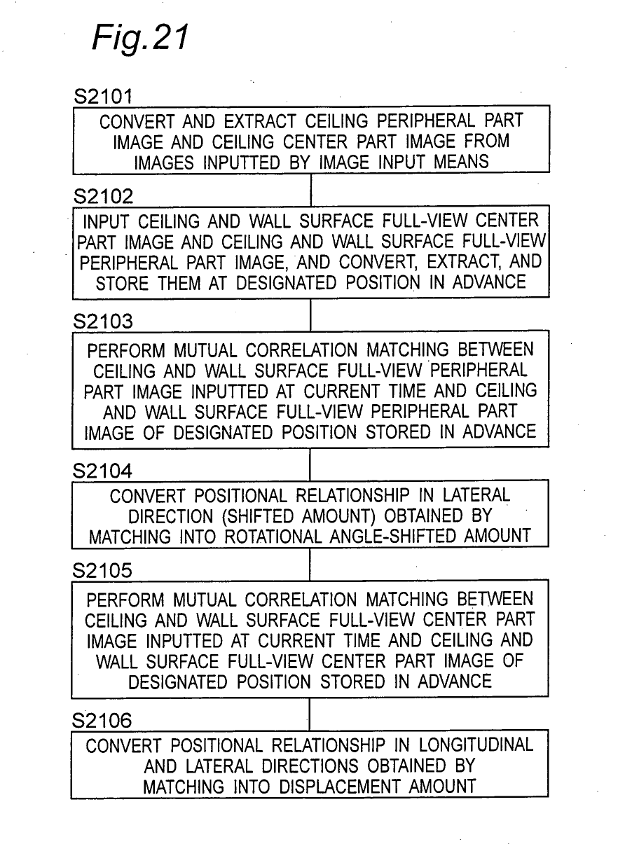

Hereinafter, actions and effects of the positioning device and the positioning method of the robot 1 configured as described above and the control, apparatus and the control method of the robot 1 thereof will be explained. FIG. 21 is a control flowchart of a mobile robot positioning method according to the third embodiment.

As shown in FIG. 20B, an omnidirectional camera processing unit 412 includes a conversion extraction unit 412a, a conversion extraction storage unit 412f, a first mutual correlation matching unit 412b, a rotational angle-shifted amount conversion unit 412c, a second mutual correlation matching unit 412d, and a displacement amount conversion unit 412e.

The conversion extraction unit 412a converts and extracts a full-view peripheral part image of the ceiling 114 and the wall surface 113 and a full-view center part image of the ceiling 114 and the wall surface 113 from images inputted from the omnidirectional camera 411 serving as an example of an image input unit (step S2101).

The conversion extraction storage unit 412f converts, extracts, and stores the ceiling and wall surface full-view center part image and the ceiling and wall surface full-view peripheral part image which have been inputted from the conversion extraction unit 412a at a designated position in advance (step S2102).

The first mutual correlation matching unit 412b performs mutual correlation matching between the ceiling and wall surface full-view peripheral part images inputted at the current time (a time performing the positioning operation) and the ceiling and wall surface full-view peripheral part image of the designated position stored on the conversion extraction storage unit 412f in advance (step S2103).

The rotational angle-shifted amount conversion unit 412c converts the positional relation in a lateral direction (shifted amount) obtained from the matching by the first mutual correlation matching unit 412b into the rotational angle-shifted amount (step S2104).

The second mutual correlation matching unit 412d performs mutual correlation matching between the ceiling and wall surface full-view center part image inputted at the current time and the ceiling and wall surface full-view center part image of the designated position stored on the conversion extraction storage unit 412f in advance (step S2105).

The displacement amount conversion unit 412e converts the positional relationship in longitudinal and lateral directions obtained from the matching by the second mutual correlation matching unit 412d into the displacement amount (step S2106).

With the omnidirectional camera processing unit 412 having such a configuration, matching is performed between the ceiling and wall surface full-view image serving as a reference of known positional posture and the ceiling and wall surface full-view image inputted, positional posture shift detection (detection of rotational angle-shifted amount obtained by the rotational angle-shifted amount conversion unit and displacement amount obtained by the displacement amount conversion unit) is performed, thus the robot's position is recognized, and the drive unit 10 is drive-controlled by the control unit 50 so as to correct the rotational angle-shifted amount and the displacement amount to be in an allowable area respectively, whereby the robot control apparatus controls the robot 1 to move autonomously. This will be explained in detail below. Note that autonomous movement of the robot 1 mentioned here means movement of the robot 1 following a mobile body such as a human 102 along the path that the mobile body such as the human 102 moves so as to keep a certain distance such that the distance between the robot 1 and the mobile body such as the human 102 is to be in an allowable area and that the direction from the robot 1 to the mobile body such as the human 102 is to be in an allowable area.

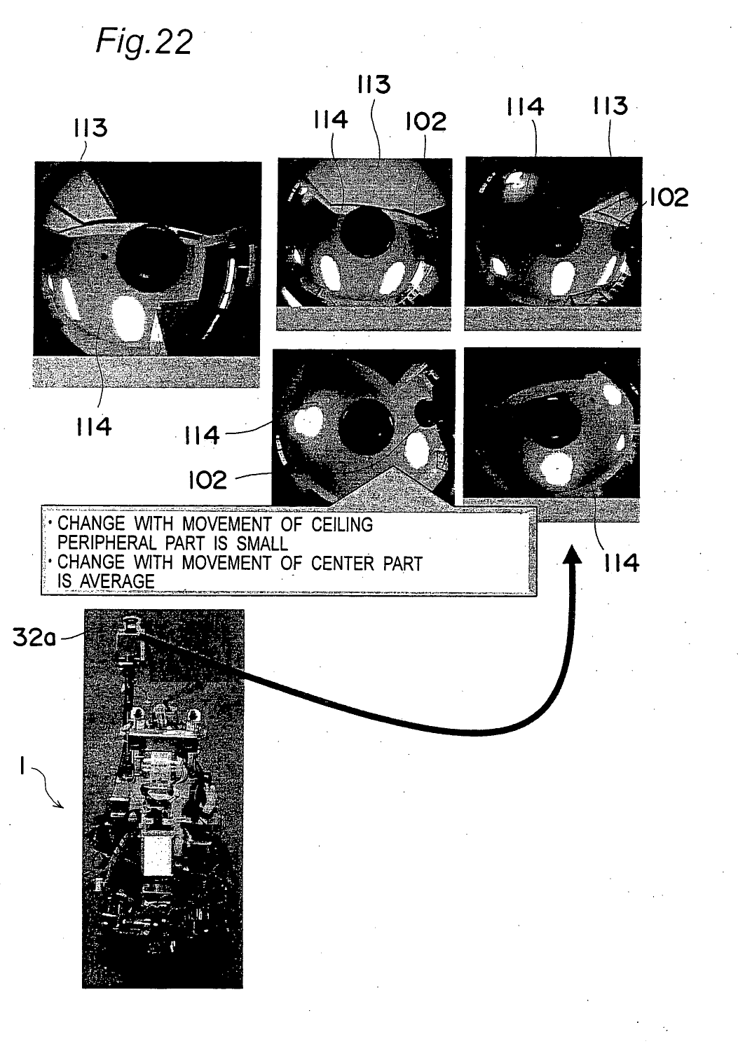

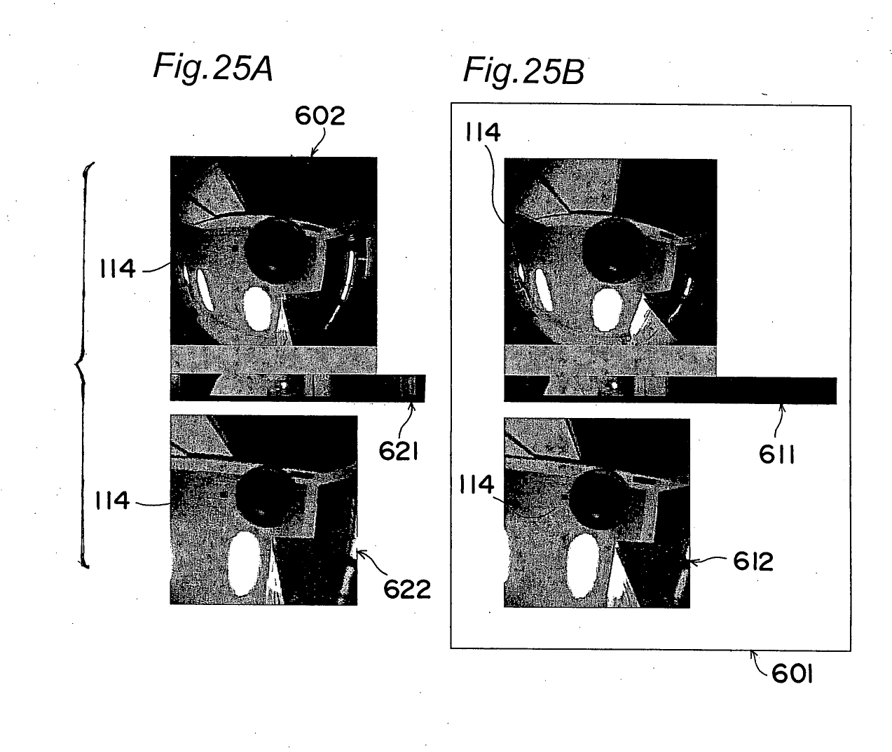

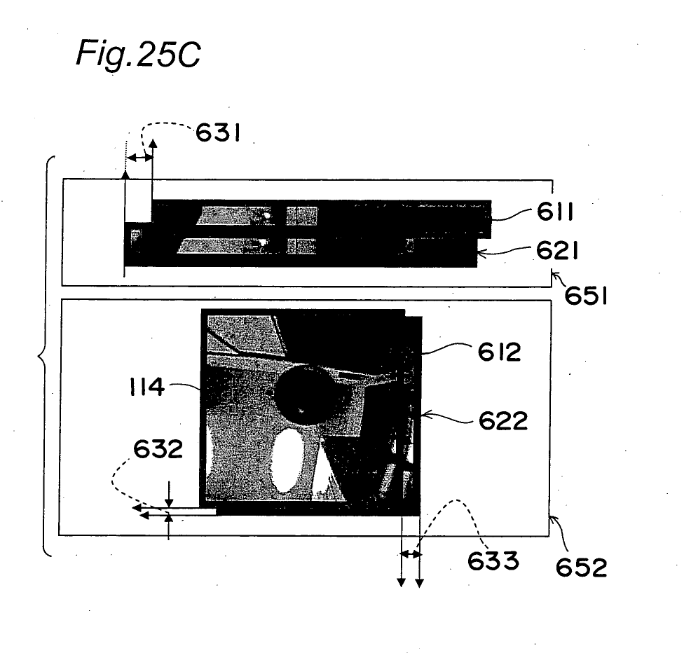

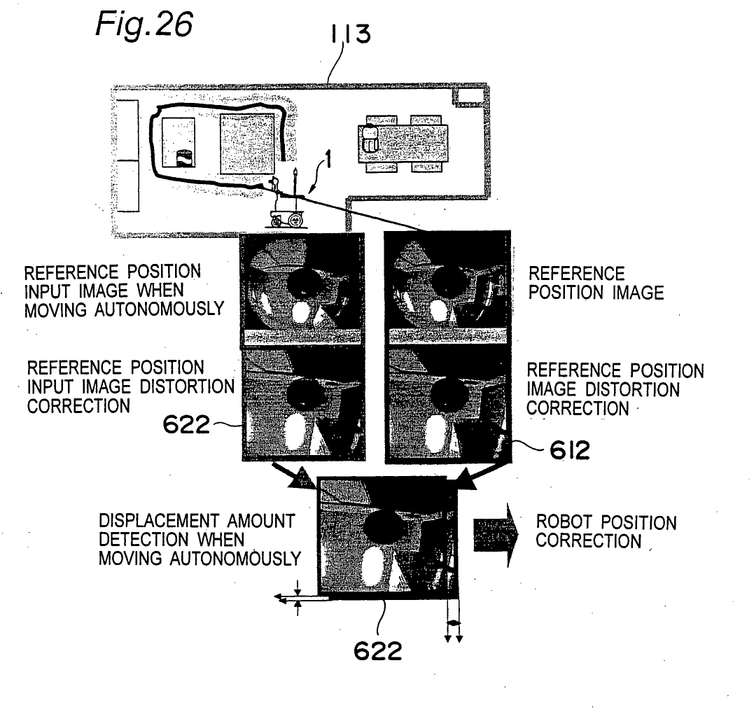

First, by using the omnidirectional camera 411 serving as an example of the omnidirectional image input unit, the omnidirectional camera height adjusting unit 413 for arranging the omnidirectional camera 411, serving as the omnidirectional image input unit, toward the ceiling 114 and the wall surface 113 in a height-adjustable manner, and the conversion extraction unit 412a for converting and extracting the full-view peripheral part image of the ceiling 114 and the wall surface 113 and the full-view center part image of the ceiling 114 and the wall surface 113 from images inputted from the omnidirectional camera 411 serving as the image input unit, the full-view center part image of the ceiling 114 and the wall surface 113 and the full-view peripheral part image of the ceiling 114 and the wall surface 113 serving as references are inputted at a designated position in advance and is converted, extracted and stored. The reference numeral 601 in FIG. 25B indicates a full-view center part image of the ceiling and the wall surface and a full-view peripheral part image of the ceiling and the wall surface, serving as references, which are inputted at a designated position in advance and converted, extracted, and stored, according to the third embodiment (see FIG. 26). In the third embodiment, a PAL-type lens or a fisheye lens is used in the omnidirectional camera 411 serving as the omnidirectional image input unit (see FIG. 22).

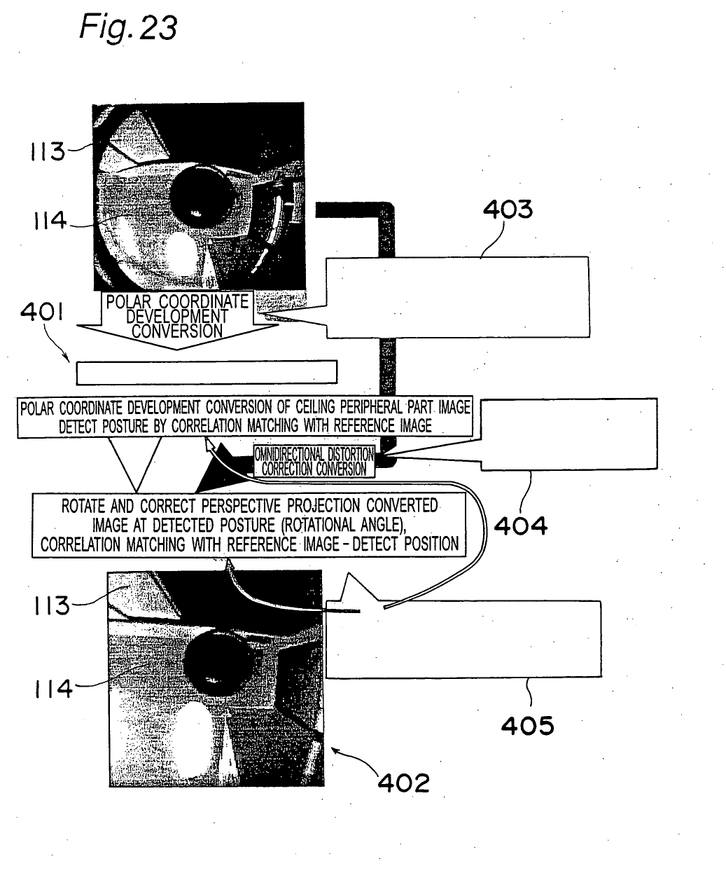

Here, an actual example of procedure of using the omnidirectional camera 411, the omnidirectional camera height adjusting unit 413 for arranging the omnidirectional camera 411 toward the ceiling and the wall surface in a height adjustable manner, and the conversion extraction unit 412a for converting and extracting the ceiling and wall surface full-view peripheral part image from images inputted by the omnidirectional camera 411 is shown in the upper half of FIG. 23 and in equations 403. An actual example of an image converted and extracted in the above procedure is 401.

i=128+(90−Y)cos {Xπ/180}

j=110+(90−Y)sin {Xπ/180} equations 403

Next, an actual example of procedure of using the omnidirectional camera 411, the omnidirectional camera height adjusting unit 413 for arranging the omnidirectional camera 411 toward the ceiling and the wall surface in a height adjustable manner, and the conversion extraction unit 412a for converting and extracting the ceiling and wall surface full-view center part image from images inputted by the omnidirectional camera 411 is shown in the lower half of FIG. 23 and in equations 404.

$$\begin{matrix}\begin{matrix}x = f ( X / D ) {tan}^{- 1} ( D / Z ) \\ y = f ( Y / D ) {tan}^{- 1} ( D / Z )\end{matrix} & equations 404 \\ R ( x , y ) = \frac{{\sum }_{i = 1}^{N} {\sum }_{j = 1}^{M} \begin{matrix}( W ( x + i , y + j ) - \overline{W} ) \cdot \\ ( T ( i , j ) - \overline{T} )\end{matrix}}{\begin{matrix}\sqrt{{\sum }_{i = 1}^{N} {\sum }_{j = 1}^{M} {( W ( x + i , y + j ) - \overline{W} )}^{2}} \cdot \\ \sqrt{{\sum }_{i = 1}^{N} {\sum }_{j = 1}^{M} {( T ( i , j ) - \overline{T} )}^{2}}\end{matrix}} & equation 405\end{matrix}$$

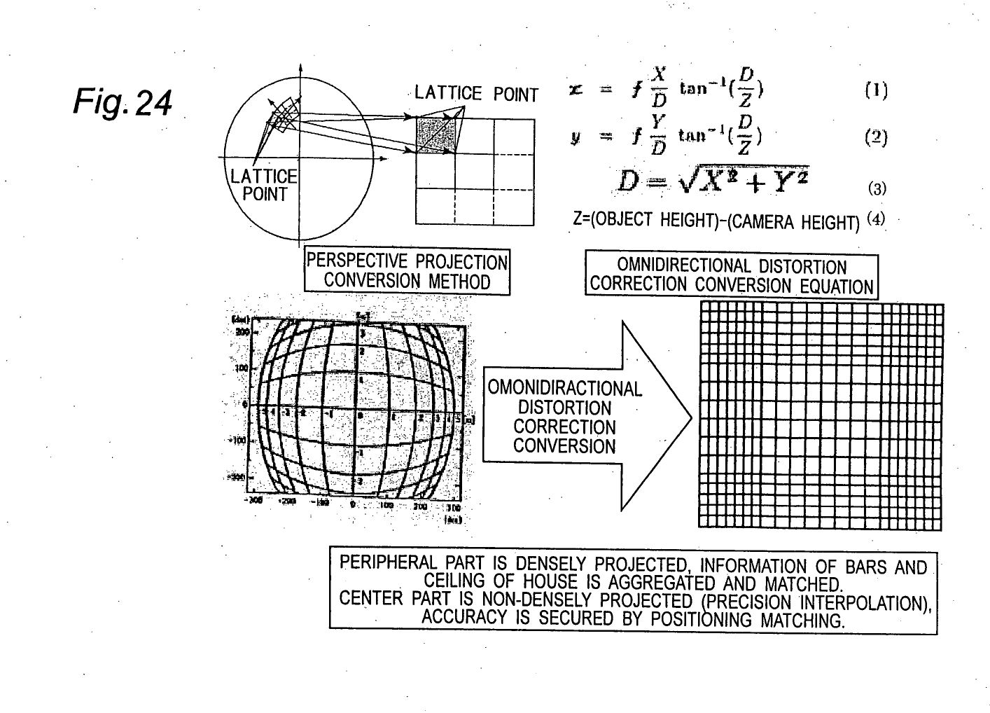

The content of the equation 405 is shown in FIG. 24. In FIG. 24, X, Y, and Z are positional coordinates of the object inputted by the omnidirectional camera 411, and x and y are positional coordinates of the object converted. Generally, the ceiling 114 has a constant height, so the Z value is assumed to be a constant value on the ceiling 114 so as to simplify the calculation. In order to calculate the Z value, a detection result performed by an object height detection unit (e.g., an ultrasonic sensor directed upward) 422, and a detection result performed by the camera height detection unit 414 are used. This is shown in the equation (4) of FIG. 24. By this conversion, surrounding distortion of the omnidirectional image input unit is removed, and the mutual correlation matching calculation described below becomes possible.

The conversion is derived to convert the polar coordinate state image into a lattice image. By inserting the term of the equation (4), a hemisphere/concentric distortion change can be included. An actual example of images extracted by the above-described procedure is shown by 402 (FIG. 23).

An actual example of a ceiling and wall surface full-view center part image, serving as a reference, which has been calculated in the above procedure and has been inputted at a designated position in advance and is extracted and stored, is shown by 612 in FIGS. 25C and 26. Further, an actual example of a ceiling and wall surface full-view peripheral part image, serving as a reference, which has been inputted at a designated position in advance and is extracted and stored, is shown by 611 in FIG. 25B.

At the current time, by using the omnidirectional camera 411, the omnidirectional camera height adjusting unit 413 for arranging the omnidirectional camera 411 toward the ceiling and the wall surface in a height adjustable manner, and the conversion extraction unit 412a for converting and extracting the ceiling and wall surface full-view peripheral part image and the ceiling and wall surface full-view center part image from images inputted by the omnidirectional camera 411, at a predetermined position, the ceiling and wall surface full-view center part image and the ceiling and wall surface full-view peripheral part image, serving as references, are inputted, converted, and extracted. The reference numerals 602, 621, and 622 in FIG. 25A and FIG. 26 are a ceiling and wall surface full-view center part image (622) and a ceiling and wall surface full-view peripheral part image (621), inputted at the current time (input image is shown by 602), converted, extracted, and stored, in one actual example.

As same as the procedure at the time of inputting, converting, extracting, and storing the ceiling and wall surface full-view center part image and the ceiling and wall surface full-view peripheral part image at a designated position in advance, the ceiling and wall surface full-view center part image and the ceiling and wall surface full-view peripheral part image at the current time are converted and extracted following the processing procedure in FIG. 23.

The reference numeral 651 in FIG. 25C shows a state of performing mutual correlation matching in one actual example between the ceiling and wall surface full-view peripheral part image inputted at the current time and the ceiling and wall surface full-view peripheral part image of a designated position stored in advance. The shifted amount 631 in a lateral direction between the ceiling and wall surface full-view peripheral part image 611 serving as a reference and the ceiling and wall surface full-view peripheral part image 621 converted and extracted and stored shows the posture (angular) shifted amount. The shifted amount in the lateral direction can be converted into the rotational angle (posture) of the robot 1.

The reference numeral 652 in FIG. 25C shows a state of performing mutual correlation matching in one actual example between the ceiling and wall surface full-view center part image inputted at the current time and the ceiling and wall surface full-view center part image of a designated position stored in advance. The shifted amounts 632 and 633 in XY lateral directions (Y-directional shifted amount 632 and X-directional shifted amount 633) between the ceiling and wall surface full-view center part image 612 serving as a reference and the ceiling and wall surface full-view center part image 622 converted and extracted and stored show the displacement amounts.

From the two displacement amounts described above, it is possible to perform positional posture shift detection so as to recognize the position of oneself. Further, in the ceiling and wall surface full-view peripheral part image and the ceiling and wall surface full-view center part image, a so-called landmark is not used.

The reason why the ceiling is used as the reference in each of the embodiments described above is that it is easy to assume the ceiling has few irregularities and has a constant height generally, so it is easily treated as a reference point. On the other hand, as for wall surfaces, there may be a mobile body, and in a case where furniture or the like is disposed, it may be moved or new furniture may be disposed, so it is hard to treat as a reference point.

Note that in the various omnidirectional camera image described above, the black circle shown in the center is the camera itself.

Note that by combining arbitrary embodiments among the various embodiments described above appropriately, effects held by respective ones can be achieved.

The present invention relates to the robot control apparatus and the robot control method for generating a path that the autonomous mobile robot can move while recognizing a movable area by autonomous movement. Here, the autonomous movement of the robot 1 means that the robot 1 moves to follow a mobile body such as a human 102 while keeping a certain distance such that the distance between the robot 1 and the mobile body such as the human 102 is in an allowable area, along the path that the mobile body such as the human 102 moves such that a direction from the robot to the mobile body such as the human 102 is in an allowable area. The present invention relates to the robot control apparatus in which a magnetic tape or a reflection tape is not provided on a part of a floor as a guiding path, but an array antenna is provided to the autonomously mobile robot and a transmitter or the like is provided to a human for example, whereby the directional angle of the human existing in front of the robot is detected time-sequentially and the robot is moved corresponding to the movement of the human, and the human walks the basic path so as to teach the following path, to thereby generate a movable path while recognizing the movable area. In the robot control apparatus and the robot control method of one aspect of the present invention, a moving path area can be taught by following a human and a robot autonomous movement. Further, in the robot control apparatus and the robot control method of another aspect of the present invention, it is possible to specify a mobile body and to detect the mobile body (distance and direction) continuously. Further, in the robot control apparatus and the robot control method of still another aspect of the present invention, it is possible to recognize a self position by performing positional posture shift detection through matching between a ceiling and wall surface full-view image serving as a reference of a known positional posture and a ceiling and wall surface full-view image inputted.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A robot control apparatus comprising:
a human movement detection unit, mounted on a mobile robot, for detecting a human existing in front of the robot, and after detecting the human, detecting movement of the human;
a drive unit, mounted on the robot, for moving the robot, at a time of teaching a path, corresponding to the movement of the human detected by the human movement detection unit;
a robot moving distance detection unit for detecting a moving distance of the robot moved by the drive unit;
a first path teaching data conversion unit for storing the moving distance data detected by the robot moving distance detection unit and converting the stored moving distance data into path teaching data;
a surrounding object detection unit, mounted on the robot, having an omnidirectional image input system capable of taking an omnidirectional image around the robot and an obstacle detection unit capable of detecting an obstacle around the robot, for detecting the obstacle around the robot and a position of a ceiling or a wall of a space where the robot moves;
a robot movable area calculation unit for calculating a robot movable area of the robot with respect to the path teaching data from a position of the obstacle detected by the surrounding object detection unit when the robot autonomously moves by a drive of the drive unit along the path teaching data converted by the first path teaching data conversion unit; and
a moving path generation unit for generating a moving path for autonomous movement of the robot from the path teaching data and the movable area calculated by the robot movable area calculation unit; wherein
the robot is controlled by the drive of the drive unit so as to move autonomously according to the moving path generated by the moving path generation unit.

2. The robot control apparatus according to claim 1, wherein the human movement detection unit comprises:
a corresponding point position calculation arrangement unit for previously calculating and arranging a corresponding point position detected in association with movement of a mobile body including the human around the robot;
a time sequential plural image input unit for obtaining a plurality of images time sequentially;
a moving distance calculation unit for detecting corresponding points arranged by the corresponding point position calculation arrangement unit between the plurality of time sequential images obtained by the time sequential plural image obtainment arrangement unit, and calculating a moving distance between the plurality of images of the corresponding points detected;
a mobile body movement determination unit for determining whether a corresponding point conforms to the movement of the mobile body from the moving distance calculated by the moving distance calculation unit;
a mobile body area extraction unit for extracting a mobile body area from a group of corresponding points obtained by the mobile body movement determination unit;
a depth image calculation unit for calculating a depth image of a specific area around the robot;
a depth image specific area moving unit for moving the depth image specific area calculated by the depth image calculation unit so as to conform to an area of the mobile body area extracted by the mobile body area extraction unit;
a mobile body area judgment unit for judging the mobile body area of the depth image after movement by the depth image specifying area moving unit;
a mobile body position specifying unit for specifying a position of the mobile body from the depth image mobile body area obtained by the mobile body area judgment unit; and
a depth calculation unit for calculating a depth from the robot to the mobile body from the position of the mobile body specified on the depth image by the mobile body position specifying unit, and
the mobile body is specified and a depth and a direction of the mobile body are detected continuously by the human movement detection unit whereby the robot is controlled to move autonomously.

3. The robot control apparatus according to claim 1, wherein the surrounding object detection unit comprises:
an omnidirectional image input unit disposed to be directed to the ceiling and a wall surface;
a conversion extraction unit for converting and extracting a ceiling and wall surface full-view peripheral part image and a ceiling and wall surface full-view center part image from images inputted from the omnidirectional image input unit;
a conversion extraction storage unit for inputting the ceiling and wall surface full-view center part image and the ceiling and wall surface full-view peripheral part image from the conversion extraction unit and converting, extracting and storing them at a designated position in advance;
a first mutual correlation matching unit for performing mutual correlation matching between a ceiling and wall surface full-view peripheral part image inputted at a current time and the ceiling and wall surface full-view peripheral part image of the designated position stored on the conversion extraction storage unit in advance;
a rotational angle-shifted amount conversion unit for converting a positional relation in a lateral direction obtained from the matching by the first mutual correlation matching unit into a rotational angle-shifted amount;
a second mutual correlation matching unit for performing mutual correlation matching between a ceiling and wall surface full-view center part image inputted at the current time and the ceiling and wall surface full-view center part image of the designated position stored on the conversion extraction storage unit in advance; and
a displacement amount conversion unit for converting a positional relationship in longitudinal and lateral directions obtained from matching by the second mutual correlation matching unit into a displacement amount, and
matching is performed between a ceiling and wall surface full-view image serving as a reference of a known positional posture and a ceiling and wall surface full-view image inputted, and a positional posture shift of the robot including the rotational angle-shifted amount obtained by the rotational angle-shifted amount conversion unit and the displacement amount obtained by the displacement amount conversion unit is detected, whereby the robot is controlled to move autonomously by recognizing a self position from the positional posture shift.

4. The robot control apparatus according to claim 2, further comprising a teaching object mobile body identifying unit for confirming an operation of the mobile body to designate tracking travel of the robot with respect to the mobile body, wherein with respect to the mobile body confirmed by the teaching object mobile body identifying unit, the mobile body is specified and the depth and the direction of the mobile body are detected continuously whereby the robot is controlled to move autonomously.

5. The robot control apparatus according to claim 2, wherein the mobile body is a human, and the human who is the mobile body is specified and the depth and the direction between the human and the robot are detected continuously whereby the robot is controlled to move autonomously.

6. The robot control apparatus according to claim 2, further comprising a teaching object mobile body identifying unit for confirming an operation of a human who is the moving object to designate tracking travel of the robot with respect to the human, wherein with respect to the human confirmed by the teaching object mobile body identifying unit, the human is specified and the depth and the direction between the human and the robot are detected continuously whereby the robot is controlled to move autonomously.

7. The robot control apparatus according to claim 2, wherein the human movement detection unit comprises:
an omnidirectional time sequential plural image obtaining unit for obtaining a plurality of omnidirectional, time sequential images of the robot; and
a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and
the mobile body is specified and the depth and the direction between the mobile body and the robot are detected continuously whereby the robot is controlled to move autonomously.

8. The robot control apparatus according to claim 3, wherein the human movement detection unit comprises:
an omnidirectional time sequential plural image obtaining unit for obtaining a plurality of omnidirectional time sequential images of the robot; and
a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and
the mobile body is specified, and the depth and the direction between the mobile body and the robot are detected continuously whereby the robot is controlled to move autonomously.

9. The robot control apparatus according to claim 4, wherein the human movement detection unit comprises:
an omnidirectional time sequential plural image obtaining unit for obtaining a plurality of omnidirectional time sequential images of the robot; and
a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and
the mobile body is specified and the depth and the direction between the mobile body and the robot are detected continuously whereby the robot is controlled to move autonomously.

10. The robot control apparatus according to claim 5, wherein the human movement detection unit comprises:
an omnidirectional time sequential plural image obtaining unit for obtaining a plurality of omnidirectional time sequential images of the robot; and
a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and
the mobile body is specified, and the depth and the direction between the mobile body and the robot are detected continuously whereby the robot is controlled to move autonomously.

11. The robot control apparatus according to claim 6, wherein the human movement detection unit comprises:
an omnidirectional time sequential plural image obtaining unit for obtaining a plurality of omnidirectional time sequential images of the robot; and
a moving distance calculation unit for detecting the corresponding points between the plurality of time sequential images obtained by the omnidirectional time sequential plural image obtaining unit, and calculating a moving distance of the corresponding points between the plurality of images so as to detect movement of the mobile body, and
the mobile body is specified and the depth and the direction between the mobile body and the robot are detected continuously whereby the robot is controlled to move autonomously.

12. The robot control apparatus according to claim 5, further comprising a corresponding point position calculation arrangement changing unit for changing a corresponding point position calculated, arranged, and detected in association with the movement of the human in advance according to the human position each time, wherein
the human is specified, and the depth and the direction between the human and the robot are detected whereby the robot is controlled to move autonomously.

13. The robot control apparatus according to claim 1, comprising:
an omnidirectional image input unit capable of obtaining an omnidirectional image around the robot;
an omnidirectional camera height adjusting unit for arranging the image input unit toward the ceiling and a wall surface in a height adjustable manner;
a conversion extraction unit for converting and extracting a ceiling and wall surface full-view peripheral part image and a ceiling and wall surface full-view center part image from images inputted from the image input unit;
a conversion extraction storage unit for inputting the ceiling and wall surface full-view center part image and the ceiling and wall surface full-view peripheral part image from the conversion extraction unit and converting, extracting and storing the ceiling and wall surface full-view center part image and the ceiling and wall surface full-view peripheral part image at a designated position in advance;
a first mutual correlation matching unit for performing mutual correlation matching between a ceiling and wall surface full-view peripheral part image inputted at a current time and the ceiling and wall surface full-view peripheral part image of the designated position stored on the conversion extraction storage unit in advance;
a rotational angle-shifted amount conversion unit for converting a shifted amount which is a positional relationship in a lateral direction obtained from the matching by the first mutual correlation matching unit into a rotational angle-shifted amount;
a second mutual correlation matching unit for performing mutual correlation matching between a ceiling and wall surface full-view center part image inputted at a current time and the ceiling and wall surface full-view center part image of the designated position stored on the conversion extraction storage unit in advance; and
a unit for converting a positional relationship in longitudinal and lateral directions obtained from the matching by the second mutual correlation matching unit into a displacement amount, wherein
matching is performed between a ceiling and wall surface full-view image serving as a reference of a known positional posture and a ceiling and wall surface full-view image inputted, and a positional posture shift detection is performed based on the rotational angle-shifted amount obtained by the rotational angle-shifted amount conversion unit and the displacement amount obtained by the displacement amount conversion unit whereby the robot is controlled to move autonomously by recognizing a self position of the robot.
